(19) United States
(12) Patent Application Publication
(10) Pub. No.: US 2026/0044921 A1
(43) Pub. Date: Feb. 12, 2026

(54) RESONANT VOLTAGE NOISE-FREE ARCHITECTURE FOR GRAPHICS PROCESSORS

(71) Applicant: QUALCOMM Incorporated, San Diego, CA (US)

(72) Inventors: Darshan Kumar NANDANWAR, Bangalore (IN); Ankit GOSALIA, Milpitas, CA (US); Shyam Sundar BALASUBRAMANIAN, Bengaluru (IN)

(21) Appl. No.: 18/801,365

(22) Filed: Aug. 12, 2024

(51) Int. Cl. G06T 1/20; G06F 9/30

(52) U.S. Cl. CPC G06T 1/20; G06F 9/30094

(57) ABSTRACT

Aspects presented herein relate to methods and devices for graphics processing including an apparatus, e.g., a GPU. The apparatus may obtain an indication of a set of graphics instructions. The apparatus may also determine whether each graphics instruction in the set of graphics instructions is associated with a resonance frequency that is above or below a threshold. Further, the apparatus may adjust an activity level for each graphics instruction in the set of graphics instructions based on the resonance frequency being above or below the threshold.

### TECHNICAL FIELD

The present disclosure relates generally to processing systems and, more particularly, to one or more techniques for graphics processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor is configured to convert digital information received from a CPU to analog values and may issue commands to a display panel for displaying the visual content. A device that provides content for visual presentation on a display may utilize a GPU and/or a display processor.

A graphics processor of a device may be configured to perform the processes in a graphics processing pipeline. Further, graphics processors may utilize a number of different architectures, such as sub-architectures or microarchitectures. However, there has developed a need for improved graphics architectures.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a graphics processing unit (GPU), a central processing unit (CPU), or any apparatus that may perform for graphics processing. The apparatus may monitor, during a resonance period, for an indication of a set of graphics instructions prior to obtaining the indication of the set of graphics instructions. The apparatus may also obtain an indication of a set of graphics instructions. The apparatus may also determine whether each graphics instruction in the set of graphics instructions is associated with a resonance frequency that is above or below a threshold. Additionally, the apparatus may output, based on the determination, an indication to adjust the activity level of each graphics instruction in the set of graphics instructions based on the resonance frequency being above or below the threshold. The apparatus may also adjust an activity level for each graphics instruction in the set of graphics instructions based on the resonance frequency being above or below the threshold. Moreover, the apparatus may output an indication of a set of dummy warps to indicate the adjustment of the activity level of each graphics instruction in the set of graphics instructions. The apparatus may also refrain from adjusting the activity level of any graphics instruction in the set of graphics instructions that is outside of a resonance period. The apparatus may also output an indication of the adjustment of the activity level of each graphics instruction in the set of graphics instructions.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram that illustrates an example content generation system in accordance with one or more techniques of this disclosure.

FIG. 2 illustrates an example graphics processing unit (GPU) in accordance with one or more techniques of this disclosure.

FIG. 3 is a diagram illustrating example processing components in accordance with one or more techniques of this disclosure.

FIG. 4 is a diagram illustrating an example GPU hardware in accordance with one or more techniques of this disclosure.

FIG. 5 is a diagram illustrating an example GPU in accordance with one or more techniques of this disclosure.

FIG. 6 is a diagram illustrating an example GPU in accordance with one or more techniques of this disclosure.

FIG. 7 includes diagrams illustrating an example GPU architecture and application structure in accordance with one or more techniques of this disclosure.

FIG. 8 is a graph illustrating an example resonance frequency in accordance with one or more techniques of this disclosure.

FIG. 9 is a graph illustrating example workloads including a resonance period and a non-resonance period in accordance with one or more techniques of this disclosure.

FIG. 10 is a graph illustrating example workloads including a resonance period and a non-resonance period in accordance with one or more techniques of this disclosure.

FIG. 11 is a diagram illustrating an example GPU pipeline in accordance with one or more techniques of this disclosure.

FIG. 12 is a communication flow diagram illustrating example communications between a GPU, a CPU/GPU, and a memory in accordance with one or more techniques of this disclosure.

FIG. 13 is a flowchart of an example method of graphics processing in accordance with one or more techniques of this disclosure.

FIG. 14 is a flowchart of an example method of graphics processing in accordance with one or more techniques of this disclosure.

### DETAILED DESCRIPTION

A resonant frequency or resonance frequency is the natural frequency at which a medium vibrates at the highest amplitude. All types of systems (e.g., system-on-chips (SoCs)) may vibrate at a natural frequency (i.e., resonant frequency or resonance frequency) depending upon their structure. When an oscillating force is applied at a resonant frequency of a dynamic system, object, or particle, the outside vibration may cause the system to oscillate at a higher amplitude (e.g., vibrate with more force) than when the same force is applied at other, non-resonant frequencies. Resonance is witnessed in objects in equilibrium with acting forces and may keep vibrating for a long time under perfect conditions. In some aspects, resonant frequency may be denoted as f₀. A resonance frequency may refer to frequencies where the system (e.g., SoC or GPU) tends to it tends to oscillate widely. Also, at the resonant frequency, there may be a large voltage drop that occurs that may drop below the minimum operating voltage. This voltage drop may be harmful to devices, so there are the reliability concerns associated with the resonant frequency of devices. Some types of devices may include a high number of threads that are processing at the device, so resonant frequency is a concern for these devices. For example, GPUs are single instruction, multiple data (SIMD) devices or single instruction, multiple thread (SIMT) devices including a high number of threads that getting executed at the device. Accordingly, addressing resonant frequency is a major challenge for GPUs. Additionally, resonance noise may be caused by periodic fluctuations in current demand that occur at certain frequencies. Resonance noise can be especially damaging to the reliability of a chip, as it generally leads to a pattern of large and repeated voltage drops. In order to improve energy efficiency, some types of GPUs (e.g., general purpose GPUs (GPGPUs)) may use a lowered V_{dd} supply. However, lowering the V_{dd} comes with the challenges like voltage noise caused by abrupt or periodic (i.e., resonant) fluctuations (e.g., noise) in the power demand. These fluctuations in power demand may be caused by variation in chip activity levels as a function of workload (e.g., a graphics workload at a GPU). If the voltage deviates too much from its nominal value, it can lead to so called voltage emergencies, which can cause timing and memory retention errors (e.g., timing and memory retention errors at a GPU). Aspects of the present disclosure may detect when voltage may deviate too much from its nominal value.

Aspects of the present disclosure may include a number of benefits or advantages. For instance, aspects of the present disclosure may detect when voltage may deviate too much from its nominal value. That is, aspects presented herein may detect when a voltage will deviate from a nominal value by more than a threshold value. Aspects presented herein may also detect a period of potential voltage resonance. For instance, aspects of the present disclosure may detect a potential fluctuation in power demand. That is, aspects presented herein may detect a variation in chip activity levels which may lead to a fluctuation in power demand. For example, may detect a variation in chip activity levels at a GPU or CPU which may lead to a fluctuation in power demand. By doing so, aspects of the present disclosure may reduce or eliminate the timing and memory retention errors that are caused by voltage emergencies (i.e., when a voltage will deviate from a nominal value by more than a threshold value). As such, aspects presented herein may increase the reliability at a GPU or CPU by detecting residence frequencies and how to schedule the workload based on the resonance frequencies. Therefore, aspects presented herein may reduce or eliminate reliability concerns at GPUs or CPUs due to voltage emergencies (i.e., when a voltage will deviate from a nominal value by more than a threshold value). Aspects presented herein may also operate GPUs with lower voltage guard bands compared to other GPUs, which will allow GPUs to be operated with a reduced overall power consumption.

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software may be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application, i.e., software, being configured to perform one or more functions. In such examples, the application may be stored on a memory, e.g., on-chip memory of a processor, system memory, or any other memory. Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

In general, this disclosure describes techniques for having a graphics processing pipeline in a single device or multiple devices, improving the rendering of graphical content, and/or reducing the load of a processing unit, i.e., any processing unit configured to perform one or more techniques described herein, such as a GPU. For example, this disclosure describes techniques for graphics processing in any device that utilizes graphics processing. Other example benefits are described throughout this disclosure.

As used herein, instances of the term “content” may refer to “graphical content,” “image,” and vice versa. This is true regardless of whether the terms are being used as an adjective, noun, or other parts of speech. In some examples, as used herein, the term “graphical content” may refer to a content produced by one or more processes of a graphics processing pipeline. In some examples, as used herein, the term “graphical content” may refer to a content produced by a processing unit configured to perform graphics processing. In some examples, as used herein, the term “graphical content” may refer to a content produced by a graphics processing unit.

In some examples, as used herein, the term “display content” may refer to content generated by a processing unit configured to perform displaying processing. In some examples, as used herein, the term “display content” may refer to content generated by a display processing unit. Graphical content may be processed to become display content. For example, a graphics processing unit may output graphical content, such as a frame, to a buffer (which may be referred to as a framebuffer). A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling, e.g., upscaling or downscaling, on a frame. In some examples, a frame may refer to a layer. In other examples, a frame may refer to two or more layers that have already been blended together to form the frame, i.e., the frame includes two or more layers, and the frame that includes two or more layers may subsequently be blended.

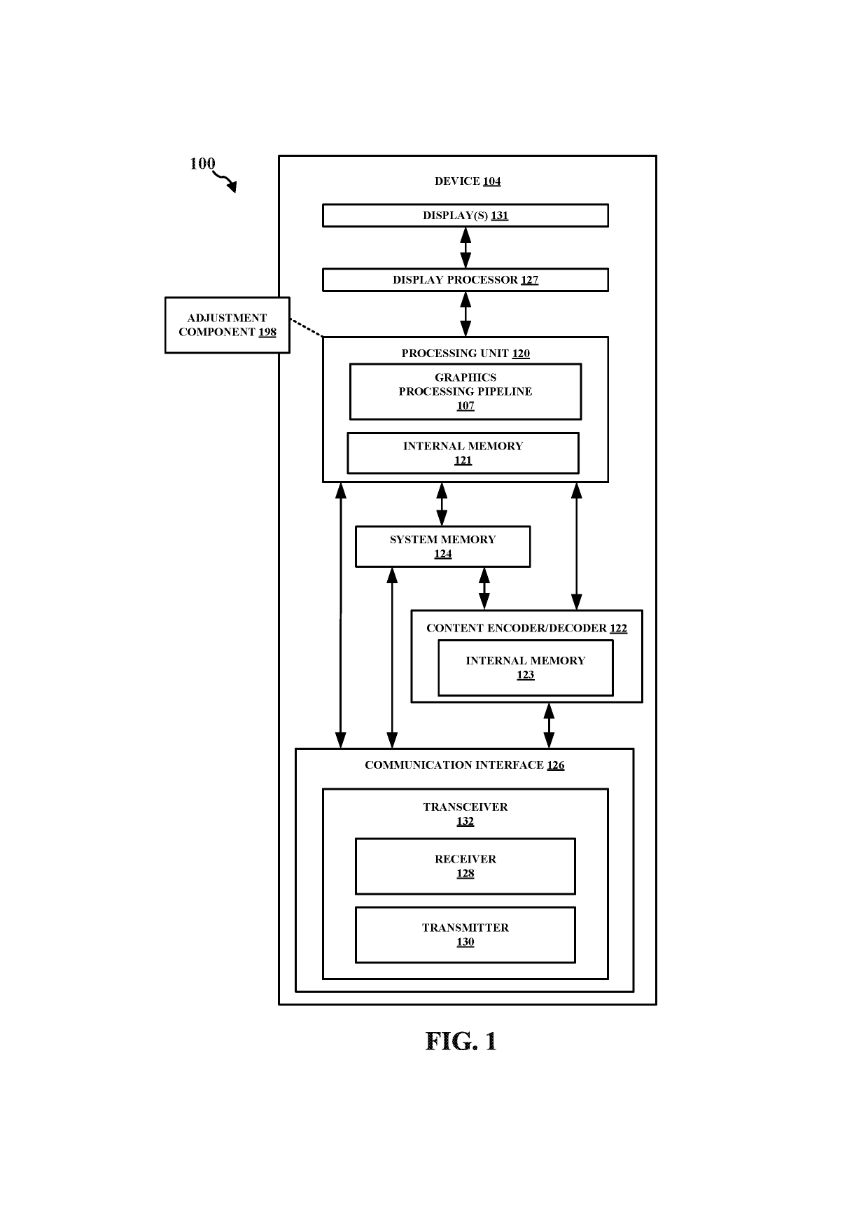

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of an SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components, e.g., a communication interface 126, a transceiver 132, a receiver 128, a transmitter 130, a display processor 127, and one or more displays 131. Reference to the display 131 may refer to the one or more displays 131. For example, the display 131 may include a single display or multiple displays. The display 131 may include a first display and a second display. The first display may be a left-eye display and the second display may be a right-eye display. In some examples, the first and second display may receive different frames for presentment thereon. In other examples, the first and second display may receive the same frames for presentment thereon. In further examples, the results of the graphics processing may not be displayed on the device, e.g., the first and second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing, such as in a graphics processing pipeline 107. The content encoder/decoder 122 may include an internal memory 123. In some examples, the device 104 may include a display processor, such as the display processor 127, to perform one or more display processing techniques on one or more frames generated by the processing unit 120 before presentment by the one or more displays 131. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of: a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 and the content encoder/decoder 122 may be communicatively coupled to the system memory 124 over a bus. In some examples, the processing unit 120 and the content encoder/decoder 122 may be communicatively coupled to each other over the bus or a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, SRAM, DRAM, erasable programmable ROM (EPROM), electrically erasable programmable ROM (EEPROM), flash memory, a magnetic data media or an optical storage media, or any other type of memory.

The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a central processing unit (CPU), a graphics processing unit (GPU), a general purpose GPU (GPGPU), or any other processing unit that may be configured to perform graphics processing. In some examples, the processing unit 120 may be integrated into a motherboard of the device 104. In some examples, the processing unit 120 may be present on a graphics card that is installed in a port in a motherboard of the device 104, or may be otherwise incorporated within a peripheral device configured to interoperate with the device 104. The processing unit 120 may include one or more processors, such as one or more microprocessors, GPUs, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include an adjustment component 198 configured to monitor, during a resonance period, for an indication of a set of graphics instructions prior to obtaining the indication of the set of graphics instructions. The adjustment component 198 may also be configured to obtain an indication of a set of graphics instructions. The adjustment component 198 may also be configured to determine whether each graphics instruction in the set of graphics instructions is associated with a resonance frequency that is above or below a threshold. The adjustment component 198 may also be configured to output, based on the determination, an indication to adjust the activity level of each graphics instruction in the set of graphics instructions based on the resonance frequency being above or below the threshold. The adjustment component 198 may also be configured to adjust an activity level for each graphics instruction in the set of graphics instructions based on the resonance frequency being above or below the threshold. The adjustment component 198 may also be configured to output an indication of a set of dummy warps to indicate the adjustment of the activity level of each graphics instruction in the set of graphics instructions. The adjustment component 198 may also be configured to refrain from adjusting the activity level of any graphics instruction in the set of graphics instructions that is outside of a resonance period. The adjustment component 198 may also be configured to output an indication of the adjustment of the activity level of each graphics instruction in the set of graphics instructions. Although the following description may be focused on graphics processing, the concepts described herein may be applicable to other similar processing techniques.

As described herein, a device, such as the device 104, may refer to any device, apparatus, or system configured to perform one or more techniques described herein. For example, a device may be a server, a base station, user equipment, a client device, a station, an access point, a computer, e.g., a personal computer, a desktop computer, a laptop computer, a tablet computer, a computer workstation, or a mainframe computer, an end product, an apparatus, a phone, a smart phone, a server, a video game platform or console, a handheld device, e.g., a portable video game device or a personal digital assistant (PDA), a wearable computing device, e.g., a smart watch, an augmented reality device, or a virtual reality device, a non-wearable device, a display or display device, a television, a television set-top box, an intermediate network device, a digital media player, a video streaming device, a content streaming device, an in-car computer, any mobile device, any device configured to generate graphical content, or any device configured to perform one or more techniques described herein. Processes herein may be described as performed by a particular component (e.g., a GPU), but, in further embodiments, may be performed using other components (e.g., a CPU), consistent with disclosed embodiments.

GPUs may process multiple types of data or data packets in a GPU pipeline. For instance, in some aspects, a GPU may process two types of data or data packets, e.g., context register packets and draw call data. A context register packet may be a set of global state information, e.g., information regarding a global register, shading program, or constant data, which may regulate how a graphics context will be processed. For example, context register packets may include information regarding a color format. In some aspects of context register packets, there may be a bit that indicates which workload belongs to a context register. Also, there may be multiple functions or programming running at the same time and/or in parallel. For example, functions or programming may describe a certain operation, e.g., the color mode or color format. Accordingly, a context register may define multiple states of a GPU.

Context states may be utilized to determine how an individual processing unit functions, e.g., a vertex fetcher (VFD), a vertex shader (VS), a shader processor, or a geometry processor, and/or in what mode the processing unit functions. In order to do so, GPUs may use context registers and programming data. In some aspects, a GPU may generate a workload, e.g., a vertex or pixel workload, in the pipeline based on the context register definition of a mode or state. Certain processing units, e.g., a VFD, may use these states to determine certain functions, e.g., how a vertex is assembled. As these modes or states may change, GPUs may need to change the corresponding context. Additionally, the workload that corresponds to the mode or state may follow the changing mode or state.

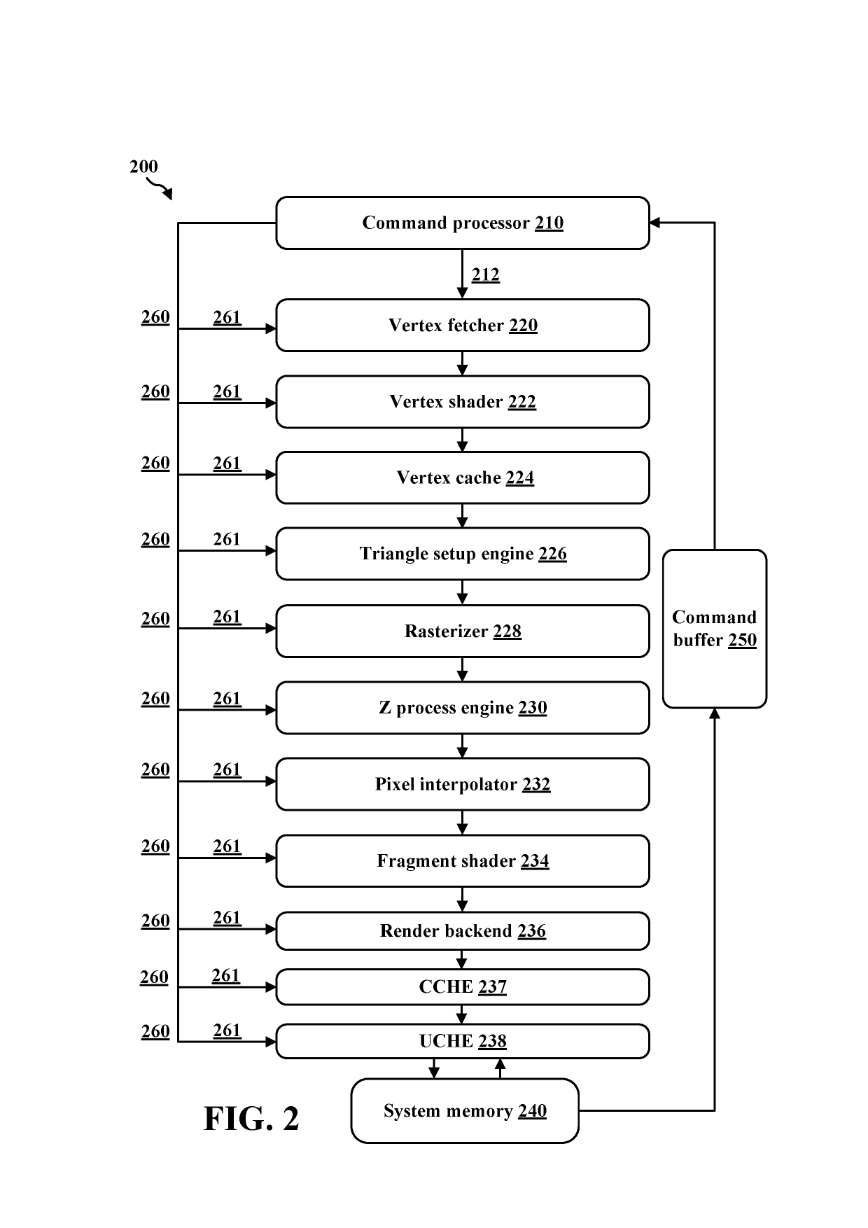

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, level 1 (L1) cache (cluster cache (CCHE)) 237, level 2 (L2) cache (UCHE) 238, and system memory 240. Although FIG. 2 displays that GPU 200 includes processing units 220-238, GPU 200 may include a number of additional processing units. Additionally, processing units 220-238 are merely an example and any combination or order of processing units may be used by GPUs according to the present disclosure. GPU 200 also includes command buffer 250, context register packets 260, and context states 261.

As shown in FIG. 2, a GPU may utilize a CP, e.g., CP 210, or hardware accelerator to parse a command buffer into context register packets, e.g., context register packets 260, and/or draw call data packets, e.g., draw call packets 212. The CP 210 may then send the context register packets 260 or draw call packets 212 through separate paths to the processing units or blocks in the GPU. Further, the command buffer 250 may alternate different states of context registers and draw calls. For example, a command buffer may be structured in the following manner: context register of context N, draw call(s) of context N, context register of context N+1, and draw call(s) of context N+1.

GPUs may render images in a variety of different ways. In some instances, GPUs may render an image using rendering and/or tiled rendering. In tiled rendering GPUs, an image may be divided or separated into different sections or tiles. After the division of the image, each section or tile may be rendered separately. Tiled rendering GPUs may divide computer graphics images into a grid format, such that each portion of the grid, i.e., a tile, is separately rendered. In some aspects, during a binning pass, an image may be divided into different bins or tiles. In some aspects, during the binning pass, a visibility stream may be constructed where visible primitives or draw calls may be identified. In contrast to tiled rendering, direct rendering does not divide the frame into smaller bins or tiles. Rather, in direct rendering, the entire frame is rendered at a single time. Additionally, some types of GPUs may allow for both tiled rendering and direct rendering.

Instructions executed by a CPU (e.g., software instructions) or a display processor may cause the CPU or the display processor to search for and/or generate a composition strategy for composing a frame based on a dynamic priority and runtime statistics associated with one or more composition strategy groups. A frame to be displayed by a physical display device, such as a display panel, may include a plurality of layers. Also, composition of the frame may be based on combining the plurality of layers into the frame (e.g., based on a frame buffer). After the plurality of layers are combined into the frame, the frame may be provided to the display panel for display thereon. The process of combining each of the plurality of layers into the frame may be referred to as composition, frame composition, a composition procedure, a composition process, or the like.

A frame composition procedure or composition strategy may correspond to a technique for composing different layers of the plurality of layers into a single frame. The plurality of layers may be stored in doubled data rate (DDR) memory. Each layer of the plurality of layers may further correspond to a separate buffer. A composer or hardware composer (HWC) associated with a block or function may determine an input of each layer/buffer and perform the frame composition procedure to generate an output indicative of a composed frame. That is, the input may be the layers and the output may be a frame composition procedure for composing the frame to be displayed on the display panel.

Some types of GPUs may include different types of pipelines, such as a graphics processing pipeline. Graphics processing pipelines may include one or more of a vertex shader stage, a hull shader stage, a domain shader stage, a geometry shader stage, and a pixel shader stage. These stages of the graphics processing pipeline may be considered shader stages. These shader stages may be implemented as one or more shader programs that execute on shader units at a GPU. Shader units may be configured as a programmable pipeline of processing components. In some examples, a shader unit may be referred to as “shader processors” or “unified shaders,” and may perform geometry, vertex, pixel, or other shading operations to render graphics. Shader units may include shader processors, each of which may include one or more components for fetching and decoding operations, one or more arithmetic logic units (ALUs) for carrying out arithmetic calculations, one or more memories, caches, and registers.

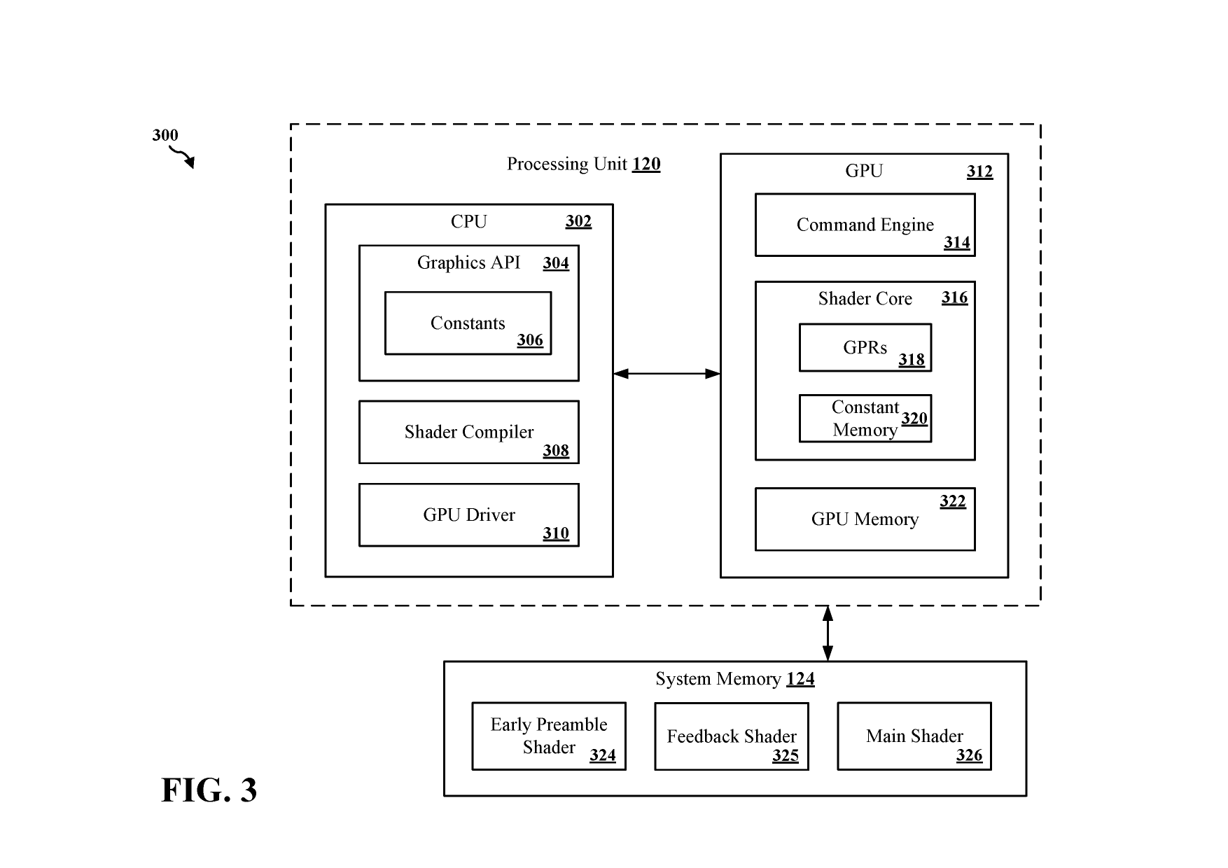

FIG. 3 is a diagram 300 that illustrates processing components, such as the processing unit 120 and the system memory 124, as may be identified in connection with the device 104 for processing data. In aspects, the processing unit 120 may include a CPU 302 and a GPU 312. The GPU 312 and the CPU 302 may be formed as an integrated circuit (e.g., a system-on-a-chip (SOC)) and/or the GPU 312 may be incorporated onto a motherboard with the CPU 302. Alternatively, the CPU 302 and the GPU 312 may be configured as distinct processing units that are communicatively coupled to each other. For example, the GPU 312 may be incorporated on a graphics card that is installed in a port of the motherboard that includes the CPU 302.

The CPU 302 may be configured to execute a software application that causes graphical content to be displayed (e.g., on the display(s) 131 of the device 104) based on one or more operations of the GPU 312. The software application may issue instructions to a graphics application program interface (API) 304, which may be a runtime program that translates instructions received from the software application into a format that is readable by a GPU driver 310. After receiving instructions from the software application via the graphics API 304, the GPU driver 310 may control an operation of the GPU 312 based on the instructions. For example, the GPU driver 310 may generate one or more command streams that are placed into the system memory 124, where the GPU 312 is instructed to execute the command streams (e.g., via one or more system calls). A command engine 314 included in the GPU 312 is configured to retrieve the one or more commands stored in the command streams. The command engine 314 may provide commands from the command stream for execution by the GPU 312. The command engine 314 may be hardware of the GPU 312, software/firmware executing on the GPU 312, or a combination thereof. While the GPU driver 310 is configured to implement the graphics API 304, the GPU driver 310 is not limited to being configured in accordance with any particular API. The system memory 124 may store the code for the GPU driver 310, which the CPU 302 may retrieve for execution. In examples, the GPU driver 310 may be configured to allow communication between the CPU 302 and the GPU 312, such as when the CPU 302 offloads graphics or non-graphics processing tasks to the GPU 312 via the GPU driver 310.

The system memory 124 may further store source code for one or more of an early preamble shader 324, a feedback shader 325, or a main shader 326. In such configurations, a shader compiler 308 executing on the CPU 302 may compile the source code of the shaders 324-326 to create object code or intermediate code executable by a shader core 316 of the GPU 312 during runtime (e.g., at the time when the shaders 324-326 are to be executed on the shader core 316). In some examples, the shader compiler 308 may pre-compile the shaders 324-326 and store the object code or intermediate code of the shader programs in the system memory 124. The shader compiler 308 (or in another example the GPU driver 310) executing on the CPU 302 may build a shader program with multiple components including the early preamble shader 324, the feedback shader 325, and the main shader 326. The main shader 326 may correspond to a portion or the entirety of the shader program that does not include the early preamble shader 324 or the feedback shader 325. The shader compiler 308 may receive instructions to compile the shader(s) 324-326 from a program executing on the CPU 302. The shader compiler 308 may also identify constant load instructions and common operations in the shader program for including the common operations within the early preamble shader 324 (rather than the main shader 326). The shader compiler 308 may identify such common instructions, for example, based on (presently undetermined) constants 306 to be included in the common instructions. The constants 306 may be defined within the graphics API 304 to be constant across an entire draw call. The shader compiler 308 may utilize instructions such as a preamble shader start to indicate a beginning of the early preamble shader 324 and a preamble shader end to indicate an end of the early preamble shader 324. Similar instructions may be used for the feedback shader 325 and the main shader 326. The feedback shader 325 will be described in further detail below.

The shader core 316 included in the GPU 312 may include general purpose registers (GPRs) 318 and constant memory 320. The GPRs 318 may correspond to a single GPR, a GPR file, and/or a GPR bank. Each GPR in the GPRs 318 may store data accessible to a single thread. The software and/or firmware executing on GPU 312 may be a shader program 324-326, which may execute on the shader core 316 of GPU 312. The shader core 316 may be configured to execute many instances of the same instructions of the same shader program in parallel. For example, the shader core 316 may execute the main shader 326 for each pixel that defines a given shape. The shader core 316 may transmit and receive data from applications executing on the CPU 302. In examples, constants 306 used for execution of the shaders 324-326 may be stored in a constant memory 320 (e.g., a read/write constant RAM) or the GPRs 318. The shader core 316 may load the constants 306 into the constant memory 320. In further examples, execution of the early preamble shader 324 or the feedback shader 325 may cause a constant value or a set of constant values to be stored in on-chip memory such as the constant memory 320 (e.g., constant RAM), the GPU memory 322, or the system memory 124. The constant memory 320 may include memory accessible by all aspects of the shader core 316 rather than just a particular portion reserved for a particular thread such as values held in the GPRs 318.

In some aspects, different types of GPU hardware may support different types of workload execution. For instance, GPU hardware may support concurrent execution of different workloads. Concurrent execution may refer to the simultaneous execution of workloads at a GPU. Also, concurrent execution may refer to the execution of workloads in parallel at a GPU. GPU hardware may also support concurrent execution of different workloads in a time-shared manner. In some instances, concurrent execution of different workloads in a time-shared manner may improve the performance per area at the GPU. However, in other instances, concurrent execution of different workloads in a time-shared manner may reduce the performance per area at the GPU. Additionally, different types of workloads may take a different amount of processing time in various stages of the GPU pipeline. Also, these types of workloads may introduce inefficiency in GPU hardware utilization.

In some aspects, scheduling algorithms in order to time-share the GPU hardware may sequence the workload to achieve the best utilization of GPU hardware. However, some types of workloads may block the execution of other successive workloads. For instance, some workloads with a higher specification for a resource (e.g., memory access latency) may block the execution of other successive workloads, which may have reduced resource specification and a faster execution time (e.g., head of line blocking). In turn, this may reduce the overall hardware efficiency at the GPU. This kind of workload pattern is common in certain types of binning (e.g., concurrent binning). For example, in concurrent binning, a tile sorting pass for a certain frame (e.g., frame ‘N+1’) may be run concurrently with a rendering pass of another frame (e.g., frame ‘N’).

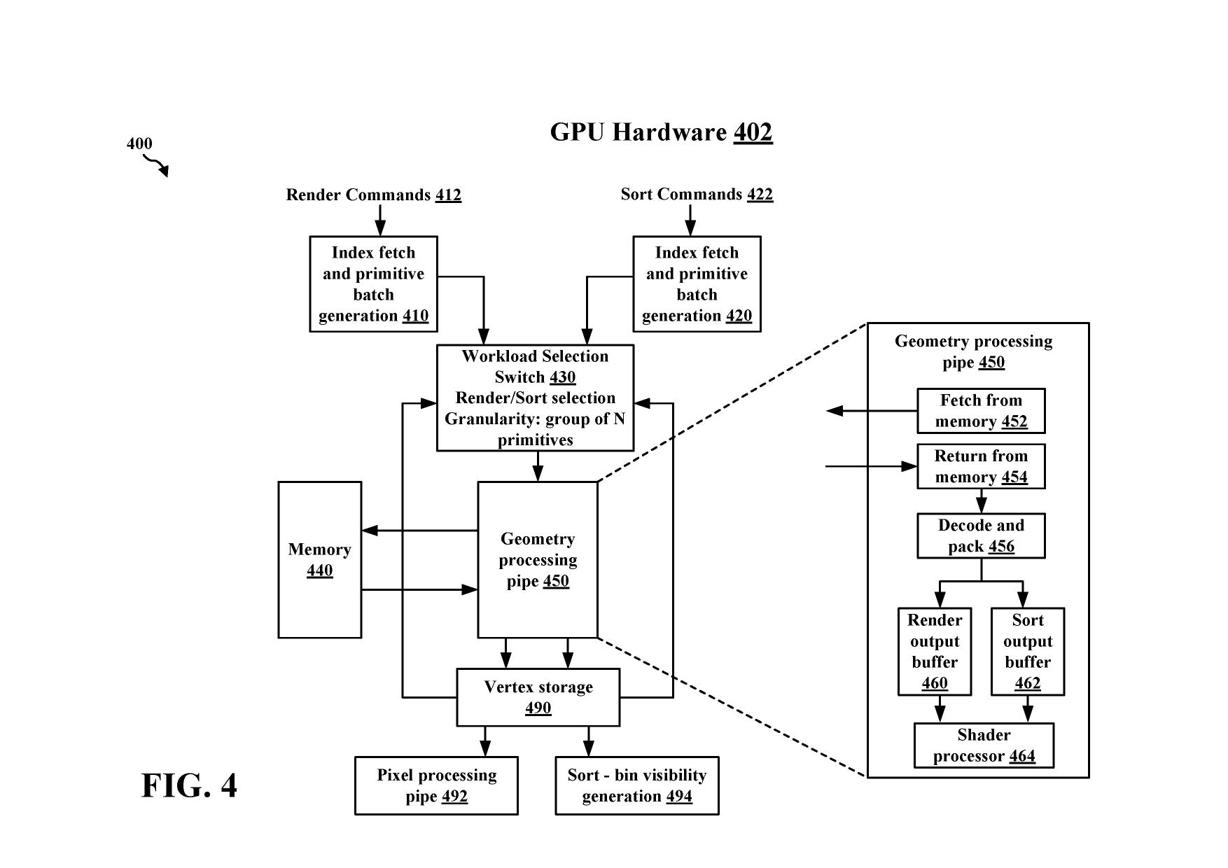

FIG. 4 illustrates diagram 400 including one example of GPU hardware. More specifically, diagram 400 depicts a time-shared GPU hardware for concurrent binning. As shown in FIG. 4, diagram 400 includes GPU hardware 402 including index fetch and primitive batch generation component 410, index fetch and primitive batch generation component 420, software 430, memory 440, geometry processing pipe 450, vertex storage component 490, pixel processing pipe 492, and sort-bin visibility generation component 494. As shown in FIG. 4, render commands 412 may be input to index fetch and primitive batch generation component 410, which may be output to software 430. Similarly, sort commands 422 may be input to index fetch and primitive batch generation component 420, which may be output to software 430. The software 430 may have a render/sort selection capability, as well as a certain granularity (e.g., a granularity for a group of N primitives). The output of software 430 may be sent to geometry processing pipe 450, which may communicate with memory 440. The geometry processing pipe 450 may include fetch from memory component 452, return from memory component 454, decode and pack component 456, render output buffer 460, sort output buffer 462, and shader processor 464. Also, the output of geometry processing pipe 450 may be sent to vertex storage component 490, which may be sent to pixel processing pipe 492 and sort-bin visibility generation component 494.

As shown in FIG. 4, geometry pipe hardware (e.g., geometry processing pipe 450) may be time shared between tile sorting and tile render workloads. Also, a scheduling algorithm (e.g., software 430) may consider the availability of GPU hardware for tile sorting and tile render workload. The granularity of a workload may be selected such that there is limited workload switching overhead. Further, the granularity of a workload may be selected such that, at the same time, one workload does not block the other. As shown in FIG. 4, the software 430 may have a granularity of a group of N primitives. For instance, for concurrent binning, the workload distribution granularity may be a primitive batch (e.g., a set of N primitives).

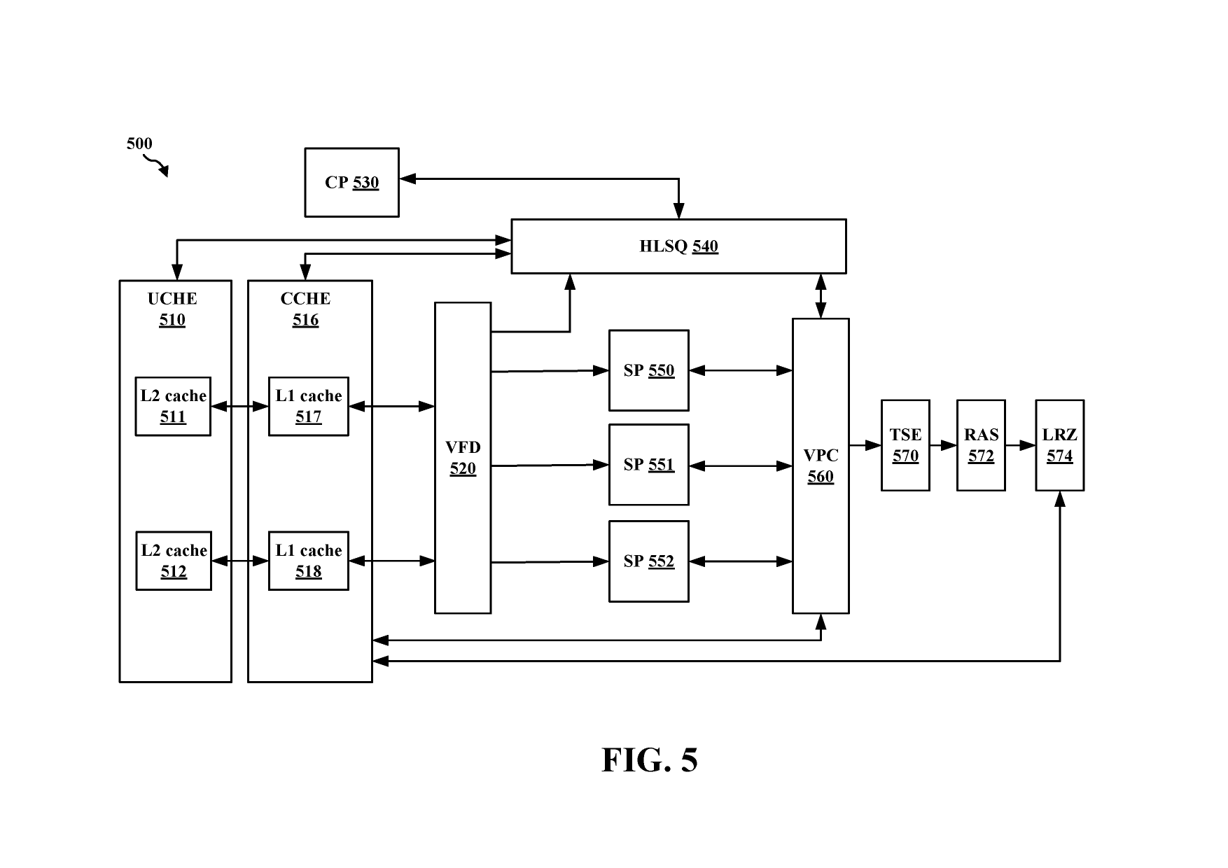

FIG. 5 is a diagram illustrating another example GPU. More specifically, FIG. 5 depicts GPU 500 including a number of different components. As shown in FIG. 5, GPU 500 includes UCHE 510 including L2 cache 511 and L2 cache 512, CCHE 516 including L1 cache 517 and L1 cache 518, VFD 520, CP 530, HLSQ 540, a number of SPs (e.g., SP 550, SP 551, and SP 552), VPC 560, TSE 570, RAS 572, and low resolution Z (LRZ) component (e.g., LRZ 574). As shown in FIG. 5, CP 530 may transmit data to HLSQ 540 and receive data from HLSQ 540. CCHE 516 may transmit/receive data to/from HLSQ 540. UCHE 510 may also transmit/receive data to/from HLSQ 540. L2 cache 511 and L2 cache 512 may transmit/receive data to/from VFD 520. Further, VFD 520 may transmit data to HLSQ 540, as well as transmit data to SPs 550-552. Moreover, SPs 550-552 may transmit/receive data to/from VPC 560. Also, VPC 560 may transmit/receive data to/from HLSQ 540. Data can also be transmitted from VPC 560 to TSE 570, which can transmit data to RAS 572, and then to LRZ 574. CCHE 516 can transmit/receive data to/from VPC 560 and LRZ 574. Also, UCHE 510 can transmit/receive data to/from VPC 560 and LRZ 574.

As indicated herein, graphics processors (e.g., GPUs) may work in a number of different fashions (e.g., a single instruction, multiple data (SIMD) fashion). GPUs may process certain types of instructions that are associated with an operation (e.g., an SIMD operation). For instance, a GPU may process wave instructions or waves, which are the width of data elements that are operated on by a single instruction associated with the SIMD. The term wave may also refer to a set of threads or blocks that run concurrently on the GPU. Waves may be allocated into sub-waves, which may include a number of threads or fibers. An active thread/fiber may refer to a thread/fiber that executes instructions (e.g., instructions in the ALU). An inactive thread/fiber may refer to a thread/fiber that does not execute instructions. Threads/fibers that do not partake in a branching operation may eventually become inactive (i.e., partake in the next level of the hierarchy). A kernel may be a programming operations manager or a programming thread at a GPU. Also, a kernel may be executed in parallel by an array of threads/fibers, where all threads/fibers may run the same code. Each thread/fiber may have an identifier (ID) that it uses to compute memory addresses and make control decisions. GPUs may also process a number of different operations, such as an atomic operation. An atomic operation may enable another operation (e.g., a read-modify-write operation or a read-write operation) to occur without any interruption. As such, an atomic operation may assure that no other execution operation at a GPU may have been inserted between the target operation (e.g., a read-modify-write operation or a read-write operation).

In some aspects, a shader in the context of a graphics processor (e.g., a GPU) may be a program that is used to control the rendering effects of 3D computer graphics. There are different types of shaders (e.g., vertex shaders, pixel shaders, and geometry shaders), each of which may handle a different aspect of the rendering process. Shaders may be used to produce realistic lighting, shadows, textures, and other visual effects in video games, simulations, and other 3D applications. A shader processor (SP) may utilize one or more context states to perform various operations and calculations. For instance, a shader processor may be part of multiple shared cores for integer processing. Also, a shader processor may execute shader code (e.g., vertex shaders, fragment shaders, compute shaders, etc.). The shader processor may also be referred to as a shader core. Shader code may also be referred to as a shader and may refer to a user-defined program configured to run in a stage of the GPU. In an example, the shader code may be associated with the rendering of graphical content. The shader processor may include a number of different components, such as arithmetic logic units (ALUs) and general purpose registers (GPRs). An ALU may be a combinatorial digital circuit that performs arithmetic and bitwise operations on integer binary numbers (e.g., a signed integer, an unsigned integer, etc.). A GPR may be a register that stores both data and addresses, that is, the GPR may be a combined data/address register. A register may refer to a location that may be accessed by a processor. A register may include a small amount of relatively quickly accessible storage.

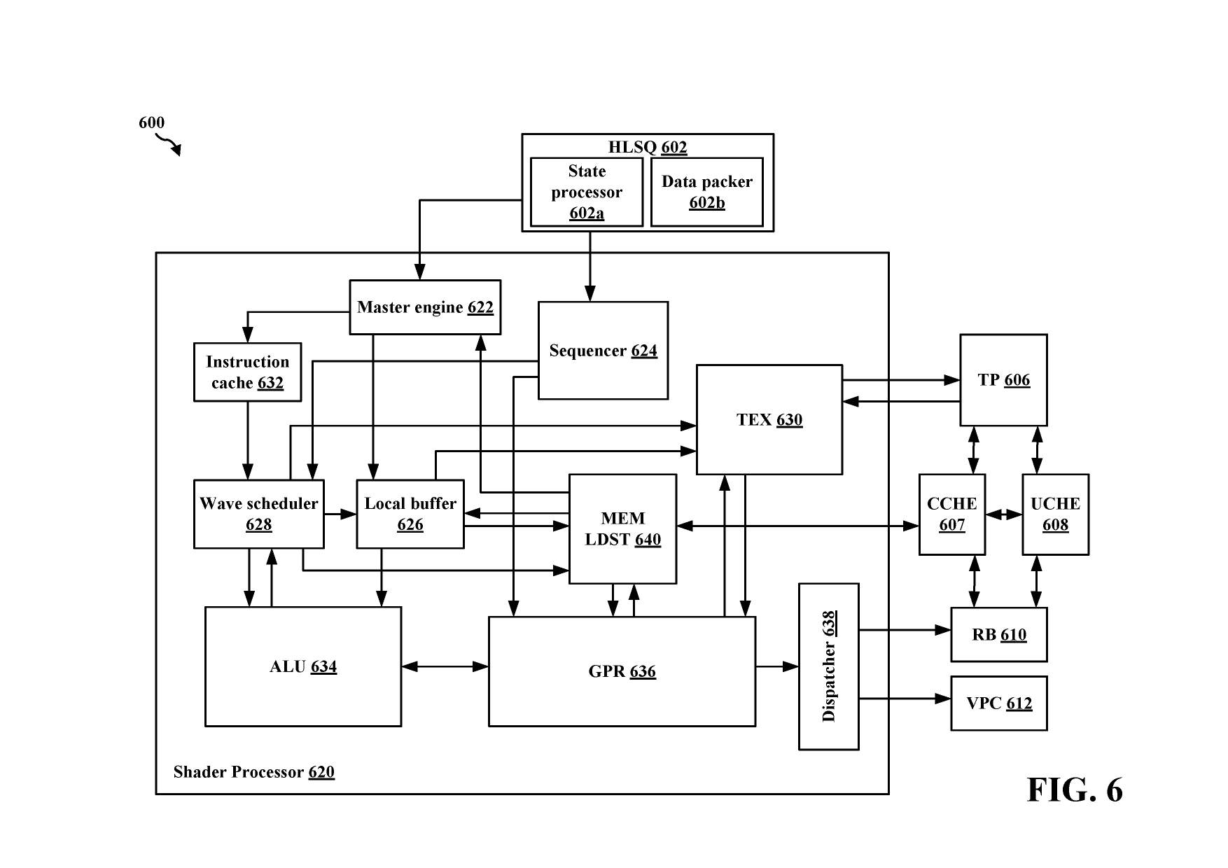

FIG. 6 illustrates an example GPU 600. Specifically, FIG. 6 illustrates a shader processor (SP) system in GPU 600. As shown in FIG. 6, GPU 600 includes a high level sequencer (HLSQ) 602, texture processor (TP) 606, level 1 (L1) cache (cluster cache (CCHE)) 607, level 2 (L2) cache (UCHE) 608, render backend (RB) 610, and vertex cache (VPC) 612. GPU 600 also includes SP 620, master engine 622, sequencer 624, local buffer 626, wave scheduler 628, texture (TEX) 630, instruction cache 632, arithmetic logic unit (ALU) 634, GPR 636, dispatcher 638, and memory (MEM) load store (LDST) 640.

As shown in FIG. 6, each unit or block in GPU 600 may send data or information to other blocks. For instance, HLSQ 602 may send commands to the master engine 622. Also, HLSQ 602 may send vertex threads, vertex attributes, pixel threads, pixel attributes, and/or compute commands to the sequencer 624. TP 606 may receive texture requests from TEX 630, and send texture elements (texels) back to the TEX 630. Further, TP 606 may send memory read requests to and receive memory data from CCHE 607 or UCHE 608. CCHE 607 or UCHE 608 may also receive memory read or write requests from MEM LDST 640 and send memory data back to MEM LDST 640, as well as receive memory read or write requests from RB 610 and send memory data back to RB 610. Also, RB 610 may receive an output in the form of color from GPR 636, e.g., via dispatcher 638. VPC 612 may also receive output in the form of vertices from GPR 636, e.g., via dispatcher 638. GPR 636 may send address data or receive write back data from MEM LDST 640. GPR 636 may also send temporary data to and receive temporary data from ALU 634. Moreover, ALU 634 may send address or predicate information to the wave scheduler 628, as well as receive instructions from wave scheduler 628. Local buffer 626 may send constant data to ALU 634. TEX 630 may also receive texture attributes from or send texture data to GPR 636, as well as receive constant data from local buffer 626. Further, TEX 630 may receive texture requests from wave scheduler 628, as well as receive constant data from local buffer 626. MEM LDST 640 may send/receive constant data to/from local buffer 626. Sequencer 624 may send wave data to wave scheduler 628, as well as send data to GPR 636. The sequencer 624 may allocate resources and local memory. Also, the sequencer 624 may allocate wave slots and any associated GPR 636 space. For example, the sequencer 624 may allocate wave slots or GPR 636 space when the HLSQ 602 issues a pixel tile workload to the SP 620. Master engine 622 may send program data to instruction cache 632, as well as send constant data to local buffer 626 and receive instructions from MEM LDST 640. Instruction cache 632 may send instructions or decode information to wave scheduler 628. Wave scheduler 628 may send read requests to local buffer 626, as well as send memory requests to MEM LDST 640.

As further shown in FIG. 6, the HLSQ 602 may prepare one or more context states for the SP 620. For example, the HLSQ 602 may prepare the context states for different types of data, e.g., global register data, shader constant data, buffer descriptors, instructions, etc. Additionally, the HLSQ 602 may embed context states into a command stream to the SP 620. The master engine 622 may parse the command stream from the HLSQ 602 and setup an SP global state. Moreover, the master engine 622 may fill or add to an instruction cache 632 and/or a local buffer 626 or a constant buffer. In some aspects, inside the HLSQ 602, there may be an internal function unit called a state processor 602a. The state processor 602a may be a single fiber scalar processor that may execute a special shader program, e.g., a preamble shader. The preamble shader may be generated by the GPU compiler in order to load constant data from different buffer objects. Also, the preamble shader may bind the buffer objects into a single constant buffer, such as a post-process constant buffer. Further, the HLSQ 602 may execute the preamble shader and, as a result, skip utilizing a main shader. In some instances, the main shader may perform different shading tasks, such as normal vertex shading and/or a fragment shading program. Moreover, the HLSQ 602 may include a data packer 602b.

Additionally, as shown in FIG. 6, the SP 620 may not be limited to executing a preamble if the HLSQ 602 decides to skip a preamble execution. For instance, the SP 620 may also process a conventional graphics workload, such as vertex shading and/or fragment shading. In some aspects, the SP 620 may utilize its execution units and storage in order to process compute tasks as a general purpose GPU (GPGPU). Inside the SP 620, there may be multiple parallel instruction execution units such as an ALU, elementary function unit (EFU), branching unit, TEX, general memory read and write (aka LDST), etc. The SP 620 may also include on-chip storage memory, such as a GPR 636 which may store per-fiber private data. Also, the SP 620 may include a local buffer 626 which stores per-shader or per-kernel constant data, per-wave uniform data (aka uGPR), and per-compute work group (WG) local memory (LM). Processing a preamble shader may take up one wave slot. Further, the majority of preamble shaders may use just the uGPR and not the GPR, and may execute ALU instructions on a scalar ALU. Therefore, execution of the preamble shader may be associated with high performance, and may be power efficient because any available wave slot may be used to execute the preamble shader even without GPR space allocation.

Moreover, as shown in FIG. 6, dispatcher 638 may fetch data from GPR 636. Dispatcher 638 may also perform format conversion, and then dispatch a final color to multiple render targets (RTs). Each RT may have one or more components, such as red (r) green (G) blue (B) alpha (A) (RGBA) data, or just an alpha component of the RGBA data. Further, each RT may be generally stored in a vector GPR, i.e., R3.0 may store red data, R3.1 may store green data, R3.2 may store blue data, etc. Also, a driver program in an SP context register may be utilized to define the GPR identifier (ID) which stores RT data.

As indicated herein, a kernel may be a programming operations manager or a programming thread at a GPU. Also, a kernel may be executed in parallel by an array of threads, where all threads may run the same code. Each thread may have an identifier (ID) that it uses to compute memory addresses and make control decisions. A warp may be a collection of threads (e.g., 32 threads) that are executed simultaneously by a symmetric multiprocessor (SM). A warp may be a basic unit of execution, where multiple warps may be executed on an SM at once. When a program on a CPU invokes a kernel grid, the blocks of the grid may be enumerated and distributed to SMs with available execution capacity. The threads of a thread block may execute concurrently on one SM, and multiple thread blocks may execute concurrently on one SM. As thread blocks terminate, new blocks are launched on the vacated SMs. The mapping between warps and thread blocks may affect the performance of the kernel. Also, a clock or GPU clock may be a logical beat or time that is used to synchronize actions of the GPU. A clock source may manage how a GPU component derives its clock.

A symmetric multiprocessor (SM) may be single instruction multiple thread processor which has multiple shared cores at a GPU (e.g., shader processors (SPs)) for integer processing, special functional units (SFUs) (e.g., for calculating functions such as sine, cosine, root mean-squared (RMS), etc.). The SM may have load store (LD/ST) units for load and store into memory/registers. The SM may also have L1 caches, shared caches and large-banked register files. A concurrent thread array (CTA) may be a basic workload unit assigned to an SM in a GPU. Threads in a CTA may be sub-grouped into a warp/wavefronts, which is the smallest execution unit sharing the same program counter. A last level cache (LLC) may be a last level of cache from a GPUs context, such as an extended cache for SMs. An interconnect unit may be a crossbar switch which does multi-master arbitration, by which GPUs are connected to rest of the world. Further, a pointer of serialization / pointer of coherence (PoS/PoC) may be point in the system-on-chip (SoC) post where every master in the system may see the same coherent copy of data.

Some aspects of graphics processing may utilize certain GPU architectures and/or application structures. For instance, aspects of graphics processing may utilize a general purpose GPU (GPGPU) architecture that includes symmetric multiprocessor (SMs), shared cores, an interconnect unit, a dynamic random access memory (DRAM), and/or a number of different caches (e.g., a first level (L1) cache, a second level (L2) cache, and/or a last level cache (LLC)). In some instances of GPU architectures, a number of SMs, shared cores, and L1 caches may be connected to an interconnect unit. The interconnect unit may be connected to L2 caches and DRAMs. Additionally, in an application structure, an application may include a number of kernels, and each of the kernels may include concurrent thread arrays (CTAs), where each CTA includes a number of warps.

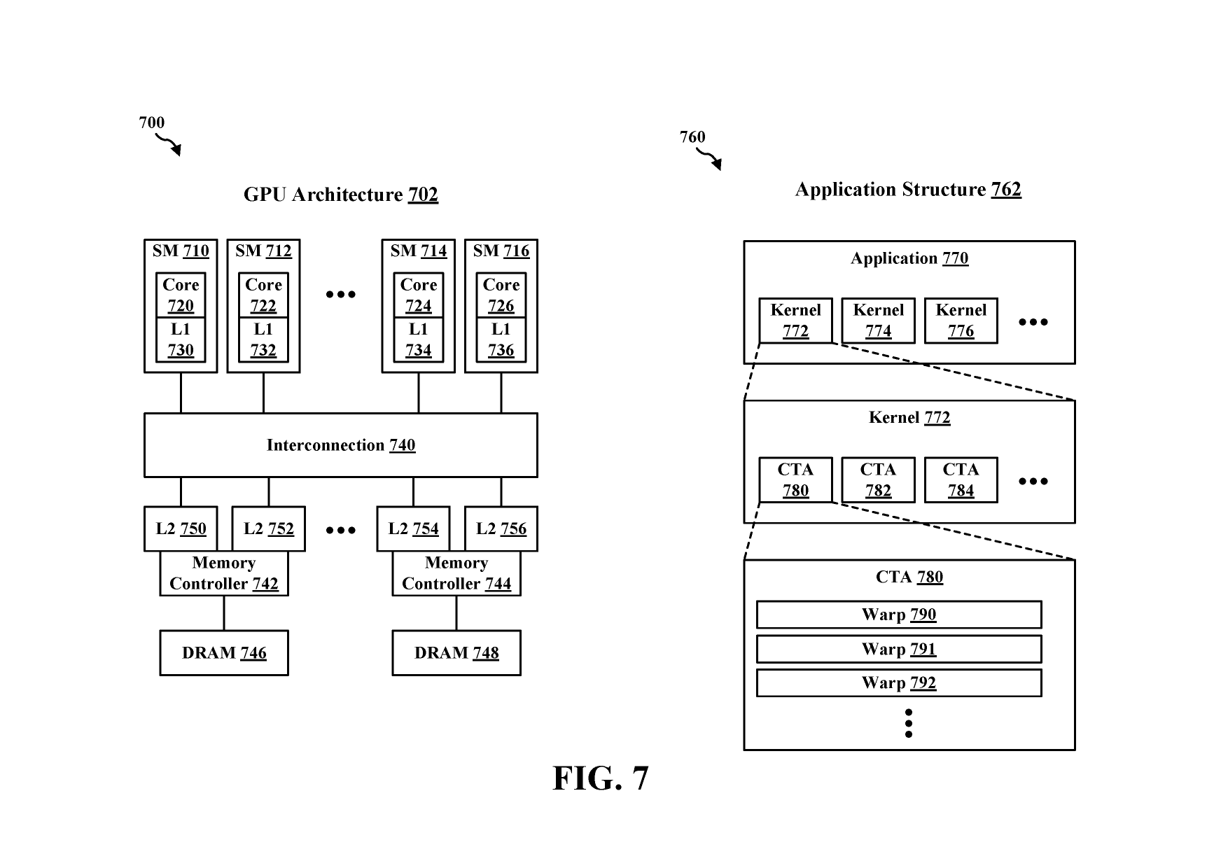

FIG. 7 illustrates diagram 700 and diagram 760 including examples of architectures and structures for a GPU or application. More specifically, diagram 700 depicts one example of an architecture for a GPU (e.g., a GPGPU) and diagram 760 depicts one example of an application structure. As shown in FIG. 7, diagram 700 includes GPU architecture 702 (e.g., a GPGPU architecture) including a number of SMs (e.g., SM 710, SM 712, SM 714, and SM 716), a number of cores (e.g., core 720, core 722, core 724, and core 726), a number of L1 caches (e.g., L1 cache 730, L1 cache 732, L1 cache 734, and L1 cache 736), and interconnection unit 740, a number of L2 caches (e.g., L2 cache 750, L2 cache 752, L2 cache 754, and L2 cache 756), memory controllers (e.g., memory controller 742 and memory controller 744), and DRAMs (e.g., DRAM 746 and DRAM 748). Diagram 700 depicts that, in some instances of GPU architectures, number of SMs (e.g., SM 710, SM 712, SM 714, and SM 716), cores (e.g., core 720, core 722, core 724, and core 726), and L1 caches (e.g., L1 cache 730, L1 cache 732, L1 cache 734, and L1 cache 736), may be connected to interconnection unit 740. Also, the interconnection unit 740 may be connected to L2 caches (e.g., L2 cache 750, L2 cache 752, L2 cache 754, and L2 cache 756), memory controllers (e.g., memory controller 742 and memory controller 744), and DRAMs (e.g., DRAM 746 and DRAM 748). As further shown in FIG. 7, diagram 760 includes application structure 762 depicting application 770 including a number of kernels (e.g., kernel 772, kernel 774, kernel 776, etc.). Each of the kernels may include a number of CTAs (e.g., kernel 772 may include CTA 780, CTA 782, CTA 784, etc.). Also, each of the CTAs may include a number of warps (e.g., CTA 780 may include warp 790, warp 791, warp 792, etc.).

A resonant frequency or resonance frequency is the natural frequency at which a medium vibrates at the highest amplitude. All types of systems (e.g., system-on-chips (SoCs)) may vibrate at a natural frequency (i.e., resonant frequency or resonance frequency) depending upon their structure. When an oscillating force is applied at a resonant frequency of a dynamic system, object, or particle, the outside vibration may cause the system to oscillate at a higher amplitude (e.g., vibrate with more force) than when the same force is applied at other, non-resonant frequencies. Resonance is witnessed in objects in equilibrium with acting forces and may keep vibrating for a long time under perfect conditions. In some aspects, resonant frequency may be denoted as f₀. A resonance frequency may refer to frequencies where the system (e.g., SoC or GPU) tends to it tends to oscillate widely. Also, at the resonant frequency, there may be a large voltage drop that occurs that may drop below the minimum operating voltage. This voltage drop may be harmful to devices, so there are the reliability concerns associated with the resonant frequency of devices. Some types of devices may include a high number of threads that are processing at the device, so resonant frequency is a concern for these devices. For example, GPUs are single instruction, multiple data (SIMD) devices or single instruction, multiple thread (SIMT) devices including a high number of threads that getting executed at the device. Accordingly, addressing resonant frequency is a major challenge for GPUs.

Additionally, resonance noise may be caused by periodic fluctuations in current demand that occur at certain frequencies. Resonance noise can be especially damaging to the reliability of a chip, as it generally leads to a pattern of large and repeated voltage drops. In order to improve energy efficiency, some types of GPUs (e.g., general purpose GPUs (GPGPUs)) may use a lowered V_{dd} supply. However, lowering the Vdd comes with the challenges like voltage noise caused by abrupt or periodic (i.e., resonant) fluctuations (e.g., noise) in the power demand. These fluctuations in power demand may be caused by variation in chip activity levels as a function of workload (e.g., a graphics workload at a GPU). If the voltage deviates too much from its nominal value, it can lead to so called voltage emergencies, which can cause timing and memory retention errors (e.g., timing and memory retention errors at a GPU). Based on the above, it may be beneficial to detect when voltage may deviate too much from its nominal value (e.g., deviate greater than a threshold value). For instance, it may be beneficial to detect a period of potential voltage resonance. It may also be beneficial to detect a potential fluctuation in power demand. That is, it may be beneficial to detect a variation in chip activity levels which may lead to a fluctuation in power demand.

Aspects of the present disclosure may detect when voltage may deviate too much from its nominal value. For example, aspects presented herein may detect when a voltage will deviate from a nominal value by more than a threshold value. Aspects presented herein may also detect a period of potential voltage resonance. For instance, aspects of the present disclosure may detect a potential fluctuation in power demand. That is, aspects presented herein may detect a variation in chip activity levels which may lead to a fluctuation in power demand. For example, may detect a variation in chip activity levels at a GPU or CPU which may lead to a fluctuation in power demand. By doing so, aspects of the present disclosure may reduce or eliminate the timing and memory retention errors that are caused by voltage emergencies (i.e., when a voltage will deviate from a nominal value by more than a threshold value). As such, aspects presented herein may increase the reliability at a GPU or CPU by detecting residence frequencies and how to schedule the workload based on the resonance frequencies. Therefore, aspects presented herein may reduce or eliminate reliability concerns at GPUs or CPUs due to voltage emergencies (i.e., when a voltage will deviate from a nominal value by more than a threshold value). Aspects presented herein may also operate GPUs with lower voltage guard bands compared to other GPUs, which will allow GPUs to be operated with a reduced overall power consumption.

Aspects presented herein may utilize a microarchitecture at the GPU that increases the reliability of GPUs. For instance, aspects presented herein may utilize a microarchitecture at the GPU that can detect and be aware of residence frequencies. Also, aspects presented herein may schedule workloads based on the resonance frequencies. Aspects presented herein may utilize a certain architecture (e.g., a microarchitecture) at the GPU (e.g., the GPU pipeline). This architecture (e.g., a microarchitecture) may help the GPU to detect periodic voltage resonance noise. Also, this architecture (e.g., a microarchitecture) may utilize changes in a warp scheduler to mitigate these voltage emergencies. By utilizing this microarchitecture at the GPU, aspects presented herein may operate GPUs with lower voltage guard bands compared to other GPUs. By doing so, aspects presented herein may reduce the overall power consumption at a GPU (e.g., reduce the overall power consumption at a GPU by an average of 21%).

As indicated herein, some types of GPUs (e.g., modern GPUs) may try to run at low voltage levels, such that the GPUs are not utilizing too much energy when running. However, when a GPU or CPU is run at a low voltage level, the voltage can deviate more than expected (e.g., deviate by more than a threshold level). If the voltage deviates by more than expected, this can lead to voltage emergencies (i.e., when a voltage will deviate from a nominal value by more than a threshold value). These voltage emergencies can cause a number of issues at a GPU or CPU, such as resonance issues, noise issues, timing issues, memory issues, etc. Aspects presented herein may allow a GPU or CPU to be run at a low voltage level (e.g., a voltage level less than a threshold) without the aforementioned voltage fluctuations. For instance, aspects presented herein may adjust the architecture (e.g., a microarchitecture) at a GPU, so that the GPU or CPU may run at a low voltage level (e.g., a voltage level less than a threshold) without the aforementioned voltage fluctuations.

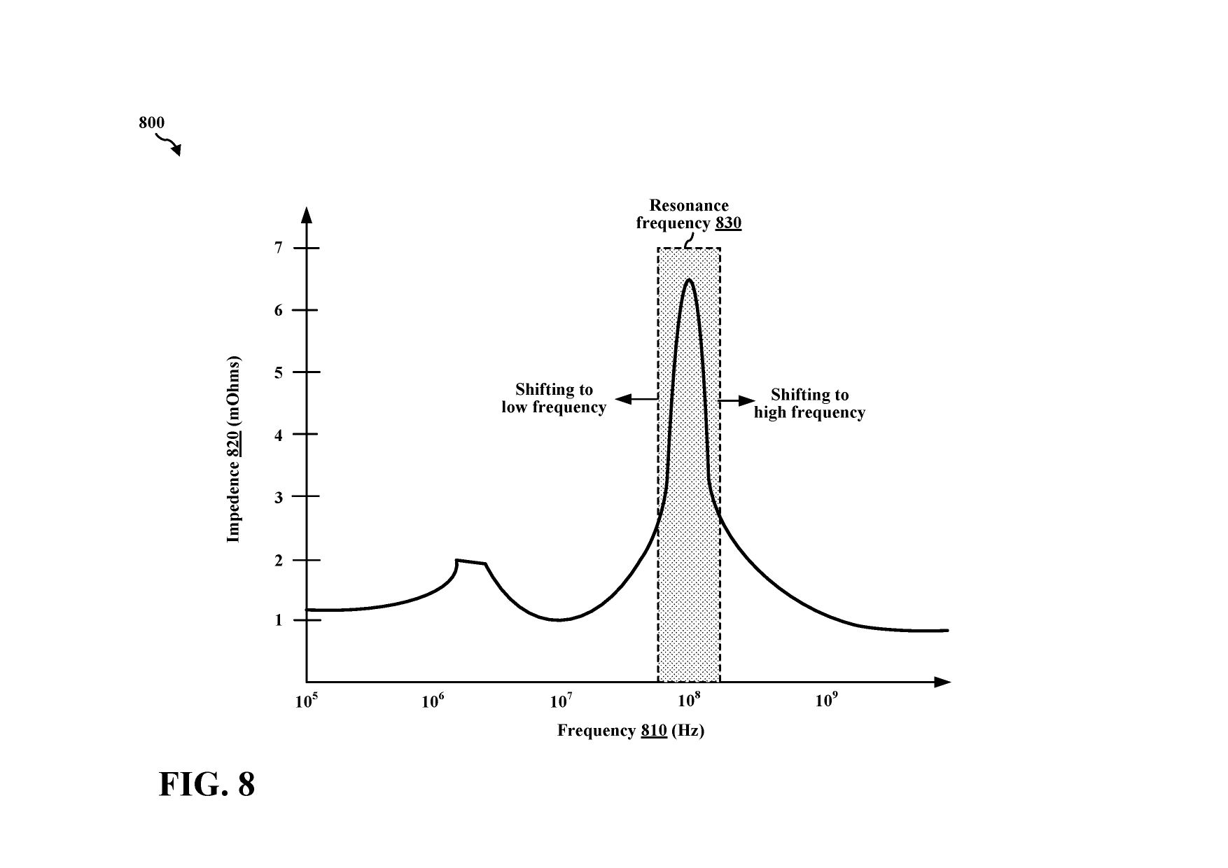

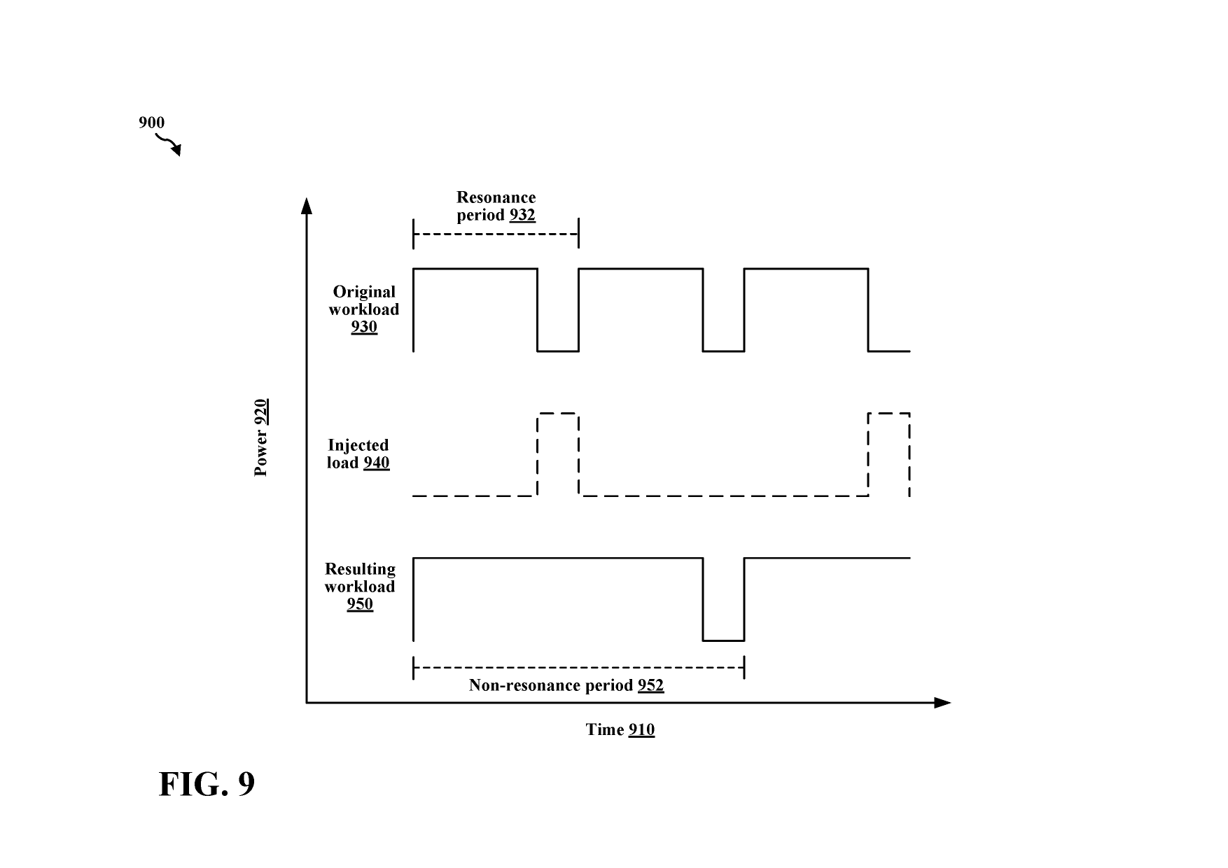

FIG. 8 is a graph 800 illustrating an example resonance frequency. More specifically, graph 800 charts a frequency at a GPU versus an impedance. As shown in FIG. 8, graph 800 includes frequency 810 (in Hz), impedance 820 (in mOhms), and resonance frequency 830. Graph 800 illustrates the impedance vs. GPU frequency plot for a typical workload (e.g., ALU and SFU operations). Graph 800 depicts that resonance frequency 830 occurs around 100 MHz (10^8 Hz), which is when the impedance 820 is higher than any other frequency band. That is, at the 100 MHz band (10^8 Hz), the impedance is at a highest level. Therefore, a change in current (di/dt) at this frequency may cause severe voltage noise. So at resonance frequency 830 when the impedance is much higher than other frequencies, there may be a high likelihood of a significant voltage drop. Aspects presented herein seek to reduce the likelihood of resonance frequency 830, such that there may not be a significant voltage drop. As shown in FIG. 9, aspects presented herein may shift the workload oscillation pattern to frequencies that are either higher or lower than the damaging resonance frequencies.

FIG. 9 is a graph 900 illustrating example workloads including a resonance period and a non-resonance period. More specifically, graph 900 charts time versus power at a GPU for an original workload and a resulting workload. As shown in FIG. 9, graph 900 includes time 910, power 920, original workload 930, resonance period 932, injected load 940, resulting workload 950, and non-resonance period 952. As illustrated in FIG. 9, an original workload 930 may correspond to a resonance period 932. Aspects presented herein may utilize an injected load 940 to shift the resulting workload 950 away from the resonance period 932, such that resulting workload 950 corresponds to a non-resonance period 952. Graph 900 depicts that a workload oscillation pattern is shifted to frequencies that are either higher or lower than the damaging resonance frequencies. This is a desired effect of the aforementioned resonance mitigation scheme of aspects presented herein. That is, aspects presented herein may inject the original workload 930 with injected load 940 in order to ensure that resulting workload 950 does not correspond to the resonance period 932. By shifting any potentially resonant activity towards a higher or lower frequency, aspects presented herein may reduce or eliminate any potential voltage drops.

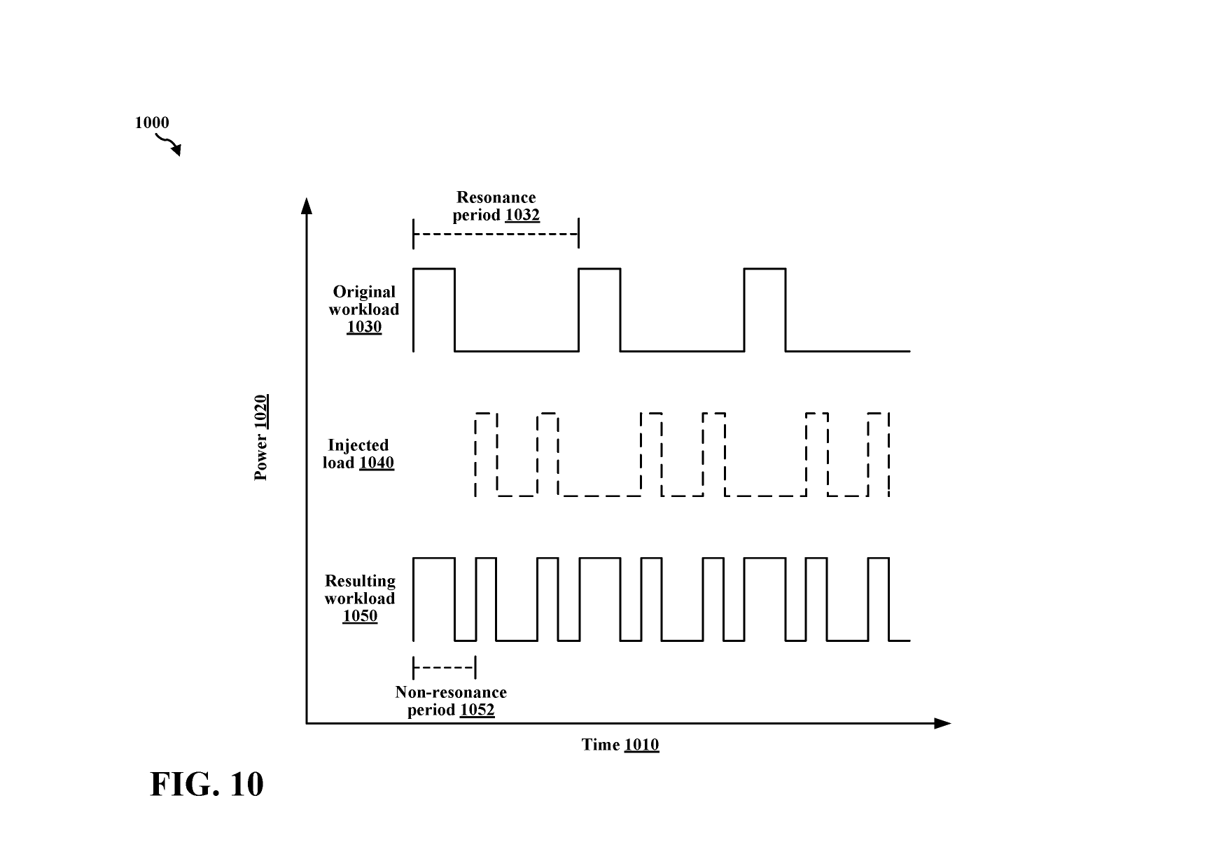

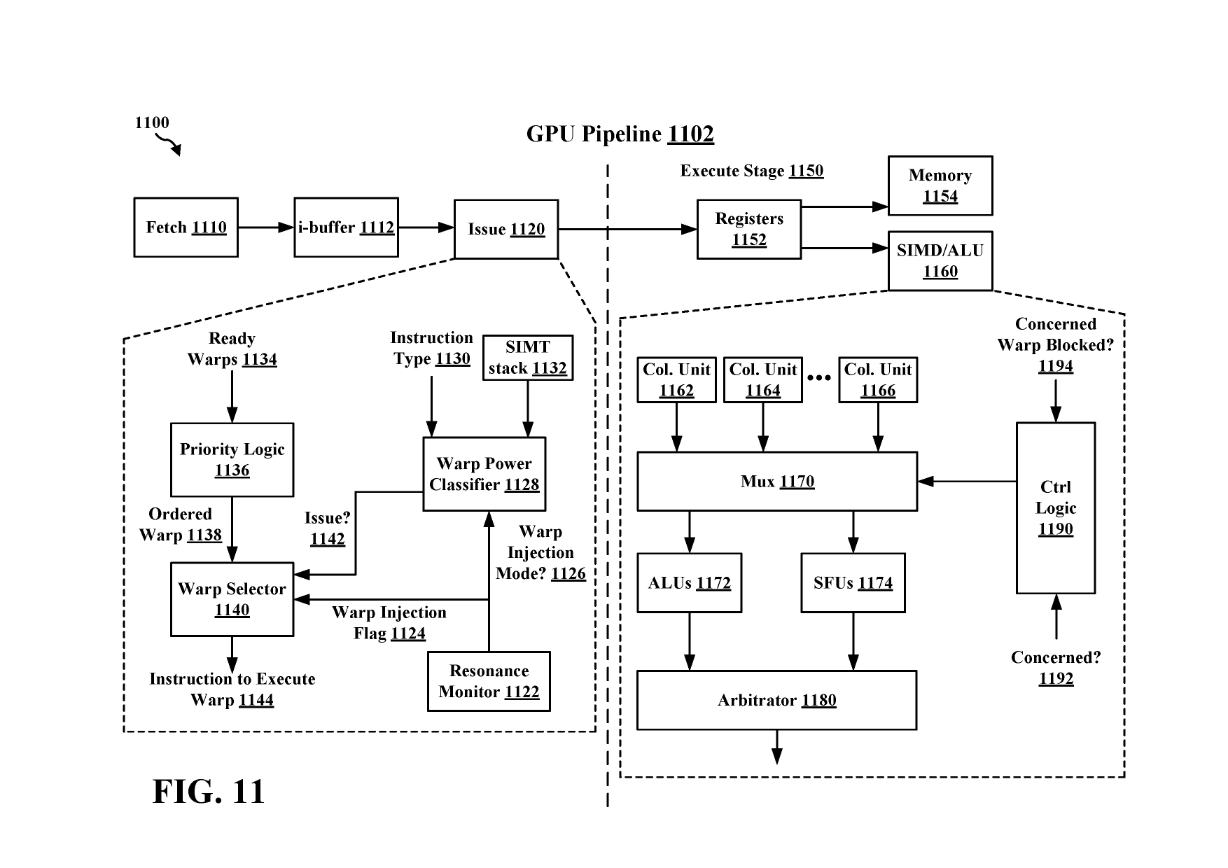

As depicted in FIG. 9, the decision of whether to shift a potentially resonant activity pattern towards a higher or a lower frequency is made based on the duty cycle observed in the workload (e.g., original workload 930). As shown in FIG. 9, if the duty cycle of the resonant signal is high (i.e., the power is high for most of the cycle period), the signal may be shifted towards lower frequencies. The process may involve altering the workload (e.g., original workload 930), such that low-power instructions may be replaced by high-power instructions. This process can be accomplished by a warp scheduler (e.g., warp selector 1140 in FIG. 11). In some instances, if no high power warps/instructions are available, an artificial load may be injected. The resulting signal may have longer periods corresponding to frequencies that are lower that the resonance region (e.g., resonance period 932). If the duty cycle of the resonant signal is low (i.e., the power is low for most of the cycle period), the signal may be shifted towards a higher frequency, as shown in FIG. 10.

FIG. 10 is a graph 1000 illustrating example workloads including a resonance period and a non-resonance period. More specifically, graph 1000 charts time versus power at a GPU for an original workload and a resulting workload. As shown in FIG. 10, graph 1000 includes time 1010, power 1020, original workload 1030, resonance period 1032, injected load 1040, resulting workload 1050, and non-resonance period 1052. As illustrated in FIG. 10, an original workload 1030 may correspond to a resonance period 1032. Aspects presented herein may utilize an injected load 1040 to shift the resulting workload 1050 away from the resonance period 1032, such that resulting workload 1050 corresponds to a non-resonance period 1052. Similar to graph 900 in FIG. 9, graph 1000 in FIG. 10 depicts that a workload oscillation pattern is shifted to frequencies that are either higher or lower than the damaging resonance frequencies, which is a desired effect of the aforementioned resonance mitigation scheme of aspects presented herein. That is, aspects presented herein may inject the original workload 1030 with injected load 1040 in order to ensure that resulting workload 1050 does not correspond to the resonance period 1032. By shifting any potentially resonant activity towards a higher or lower frequency, aspects presented herein may reduce or eliminate any potential voltage drops.

As depicted in FIG. 10, if the duty cycle of the resonant signal is low (i.e., the power is low for most of the cycle period), the signal may be shifted towards a higher frequency. This signal shift is done to minimize the power overhead introduced by the injected load 1040. Since extending the low duty cycle signal to longer non-resonant periods may utilize significant amounts of injected power, aspects presented herein may opt instead for shorter periods that utilize less power. The process involves injected load 1040, which schedules or injects a high frequency sequence of instructions into the original workload 1030, as illustrated by the dotted lines in FIG. 10. The resulting signal of the resulting workload 1050 has a frequency of oscillation that is higher than the resonance frequency.

FIG. 11 illustrates diagram 1100 including an example GPU pipeline. More specifically, diagram 1100 depicts one example of GPU pipeline 1102 including an execute stage 1150. As shown in FIG. 11, GPU pipeline 1102 includes fetch component 1110, i-buffer 1112 (i.e., scoreboard), issue stage 1120, registers 1152, memory 1154, and SIMD/ALU 1160. As shown in FIG. 11, issue stage 1120 may include a number of components, such as resonance monitor 1122, warp injection flag 1124, warp injection mode determination 1126, warp power classifier unit 1128, instruction type 1130, SIMT stack 1132, ready warps 1134, priority logic 1136, ordered warp 1138, warp selector 1140, issue determination 1142, and instruction to execute warp 1144. SIMD/ALU 1160 may include col. unit 1162, col. unit 1164, col. unit 1166, multiplexor 1170, ALUs 1172, SFUs 1174, arbitrator 1180, control logic 1190, concerned determination 1192, and concerned warp block determination 1194. Aspects presented herein may include a number of architecture changes to the GPU pipeline 1102. For example, aspects presented herein may change the GPU pipeline 1102 to include issue stage 1120, resonance monitor 1122, warp power classifier unit 1128, warp selector 1140, SIMD/ALU 1160, multiplexor 1170, and control logic 1190.

As shown in FIG. 11, aspects presented herein may include resonance monitor 1122 and warp power classifier unit 1128. As indicated herein, a warp is a collection of threads. The resonance monitor 1122 may classify instructions based on their power profile when the instructions are coming at the issue stage 1120. For instance, resonance monitor 1122 may determine whether an instruction is a high power instruction or a low power instruction. For example, a high power instruction may be a SIMD instruction and a low power instruction may be memory operations. The resonance monitor 1122 may monitor the instructions based on the power profile in a particular time window. Also, in the particular time window, the resonance monitor 1122 may monitor a duty cycle. Based on this monitoring, aspects presented herein may shift workloads to be higher or lower in order to avoid any potentially resonant activity. By shifting any potentially resonant activity towards a higher or lower frequency, aspects presented herein may reduce or eliminate any potential voltage drops. This may be accomplished by provided the warp injection flag 1124 to the warp selector 1140. The warp selector 1140 may then increase the workload activity (i.e., shift the workload activity to the right) or decrease the workload activity (i.e., shift the workload activity to the left) in order to avoid any potentially resonant activity. Whenever the warp injection flag 1124 is sent (i.e., asserted), it means that resonance monitor 1122 is asking for the more activities within the residence period. So the warp selector 1140 may increase or decrease the number of available warps. If the warp injection flag 1124 is sent (i.e., asserted), then the GPU pipeline 1102 will operate as normal.

As illustrated in FIG. 11, resonance monitor 1122 is a hardware unit that detects sequences of instructions that oscillate between high and low power at frequencies close to a resonance frequency. To detect these cases, the resonance monitor 1122 may examine the active mask of the warp scheduled for execution in the current cycle and first classify the warp as high power or low power. A warp may be considered high-power when its active lane count is above a certain threshold, and low-power when its active lane count is below a certain threshold. If the warp is determined to be high-power, the current cycle may be marked as a high-activity cycle. If the warp is determined to be low-power, the current cycle may be marked as a low-activity cycle.

Additionally, as shown in FIG. 11, when an execution transitions from a low-activity to a high-activity phase, a period counter may be started. If the next low-to-high transition occurs within a number of cycles that is lower than the resonance period of the chip, the resonance monitor 1122 may enter a “resonance mitigation mode” and stays in this mode as long as the oscillation period is within the resonance region. A duty cycle counter may record the ratio of high activity cycles vs. low activity cycles. Depending on the duty cycle, the resonance monitor 1122 may select either high-frequency or low-frequency mitigation. In high-frequency mode (which corresponds to a low duty-cycle), the monitor disrupts the resonant activity by shifting it towards higher-frequencies, as shown in FIG. 10. This may be accomplished by raising a warp injection flag 1124 in short bursts of a few cycles. In low-frequency mode (which corresponds to a high duty-cycle), the resonance monitor 1122 may raise the warp injection signal immediately in order to shift the activity pattern to a lower frequency, as shown in FIG. 9.

Further, as shown in FIG. 11, when the resonance monitor 1122 detects a region of the workload where a warp injection is needed to disrupt resonance, warp power classifier unit 1128 may be activated to identify high power instructions/warps in the list of available instructions. The classifier may rely on the active mask (coming from the SIMT stack 1132) and the instruction type (from the instruction type 1130) to make this determination. If the instruction is of a compute type (e.g., ALU or SFU) and the number of active lanes is greater than a threshold (e.g., 32 lanes for ALU or 8 lanes for SFU), the instruction may be considered high power and can be used to disrupt resonance. If the instruction is of a memory type (e.g., load, store, mem-barrier, etc.), it is classified as a low power. Given N warps in the list of active warps, the warp power classifier unit 1128 may generate an N-bit vector where element k determines if the kth warp is high (a value of 1) or low-power (a value of 0). This mask may be used by the warp selector 1140 to select high-power warps when the GPU Core is in “resonance mitigation mode.”

Additionally, as shown in FIG. 11, warp selector 1140 may be responsible for managing the warp injection process when the “resonance mitigation mode” is active. If the warp injection flag 1124 is set, the warp selector 1140 may look for a candidate in the sub-list of high-power warps. If one is found, it may be immediately dispatched for execution. Otherwise, the warp selector 1140 may examine the available low-power warps. If a ready low-power warp exists, a power boost flag may be set for that warp and it is then dispatched for execution. A power boost flag may signal to the execution unit to boost its power consumption (e.g., by activating the lanes that are masked off) when this warp arrives for execution. The warp injection flag 1124 may be attached to all warps dispatched when that mode is active. This may indicate to the execution unit to take additional measures if these warps are stalled due to dependencies. If the warp selector 1140 cannot find any warps that are ready for dispatch and the warp injection flag 1124 is still set, the warp selector 1140 may select a “dummy” warp, which contains special high power instructions (e.g., no-operation (NOP) instructions). These instructions may have no effect on the execution, but may be designed to activate functional units to bring the power consumption up as needed during warp injection cycles.

As further shown in FIG. 11, the execute stage 1150 of the GPU pipeline 1102 may examine the flags set. If a warp is marked with power boost, which indicates it may have insufficient power, the clock gating signal of inactive lanes may be canceled in order to increase power consumption. If the warp is marked as a dummy warp, clock gating may also be disabled for all lanes. If an instruction with the warp injection flag 1124 set is stalled at register access (e.g., due to a bank conflict), clock gating may be disabled for the current cycle as a substitute for the stalled warp.

Also, as shown in FIG. 11, there may be a hardware overhead in GPU pipeline 1102. For instance, in the instruction buffer, each instruction may have an additional 2-bit entry to specify its type (e.g., 0 = memory, 1 = ALU, 2 = SFU). For “dummy” warps, aspects presented herein may dedicate a single-entry stack (i.e., no divergence, so one entry is sufficient) which contains the active mask and program controller. The resonance monitor 1122 may utilize one counter for a period and two counters to keep track of high-power and low-power phases of activity. Also, the resonance monitor 1122 may utilize compare logic to detect the power level of a given mask (e.g., by counting the number of ones). The warp power classifier unit 1128 may utilize a compare (bit-count) logic for warp power classification. Further, warp selector 1140 logic may need logic to check warp readiness and power levels.

Aspects of the present disclosure may include a number of benefits or advantages. For instance, aspects of the present disclosure may detect when voltage may deviate too much from its nominal value. That is, aspects presented herein may detect when a voltage will deviate from a nominal value by more than a threshold value. Aspects presented herein may also detect a period of potential voltage resonance. For instance, aspects of the present disclosure may detect a potential fluctuation in power demand. That is, aspects presented herein may detect a variation in chip activity levels which may lead to a fluctuation in power demand. For example, may detect a variation in chip activity levels at a GPU or CPU which may lead to a fluctuation in power demand. By doing so, aspects of the present disclosure may reduce or eliminate the timing and memory retention errors that are caused by voltage emergencies (i.e., when a voltage will deviate from a nominal value by more than a threshold value). As such, aspects presented herein may increase the reliability at a GPU or CPU by detecting residence frequencies and how to schedule the workload based on the resonance frequencies. Therefore, aspects presented herein may reduce or eliminate reliability concerns at GPUs or CPUs due to voltage emergencies (i.e., when a voltage will deviate from a nominal value by more than a threshold value). Aspects presented herein may also operate GPUs with lower voltage guard bands compared to other GPUs, which will allow GPUs to be operated with a reduced overall power consumption.

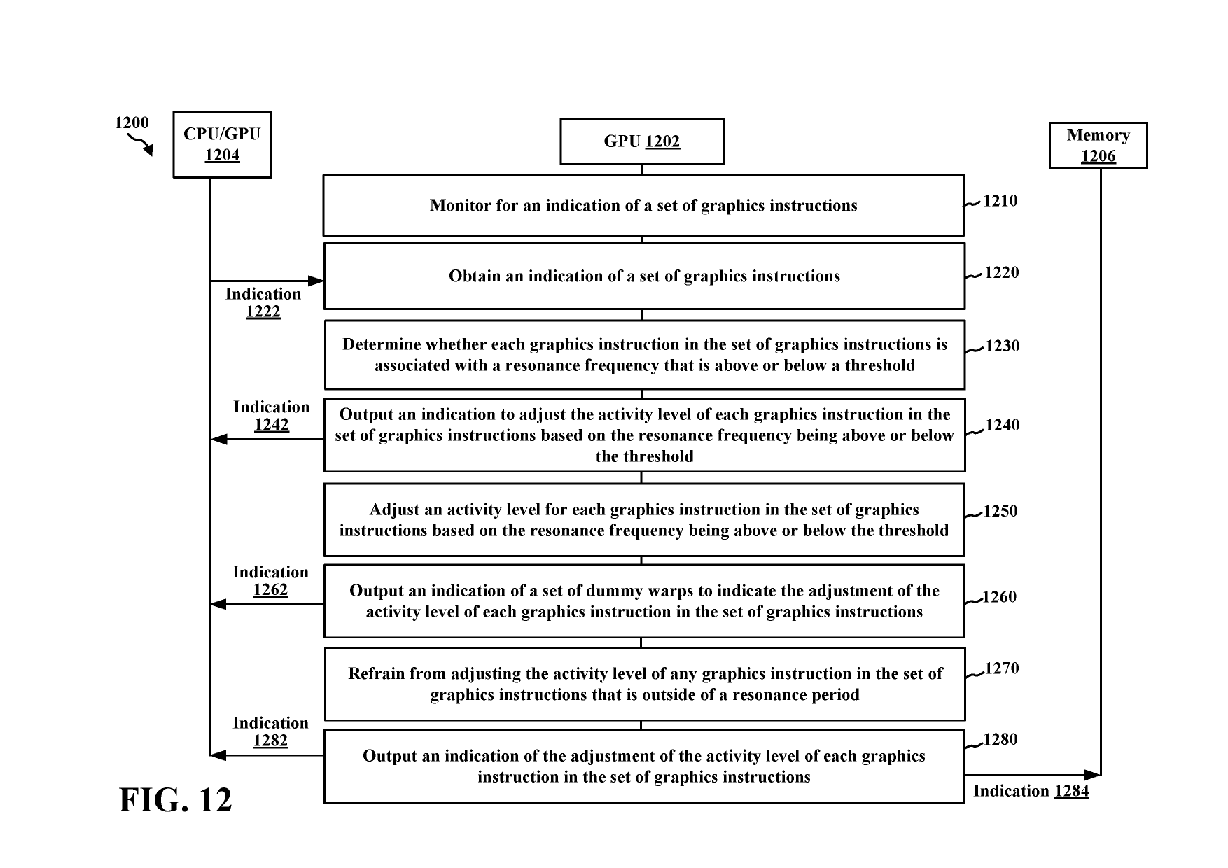

FIG. 12 is a communication flow diagram 1200 of graphics processing in accordance with one or more techniques of this disclosure. As shown in FIG. 12, diagram 1200 includes example communications between GPU 1202 (e.g., a GPU, a graphics pipeline at a GPU, a shader processor at a GPU, a GPU component, another graphics processor, a CPU, a CPU component, or another central processor), CPU/GPU 1204 (e.g., a CPU, a CPU component, or another central processor, a GPU, a graphics pipeline at a GPU, a shader processor at a GPU, a GPU component, or another graphics processor), and memory 1206 (e.g., a memory, a cache, a system memory, a graphics memory, a memory or cache at a CPU, or a memory or cache at a GPU), in accordance with one or more techniques of this disclosure.

At 1210, GPU 1202 may monitor, during a resonance period, for an indication of a set of graphics instructions prior to obtaining the indication of the set of graphics instructions.

At 1220, GPU 1202 may obtain an indication of a set of graphics instructions. For example, GPU 1202 may obtain indication 1222 from CPU/GPU 1204. In some aspects, obtaining the indication of the set of graphics instructions may comprise: obtaining the indication of the set of graphics instructions for an arithmetic logic unit (ALU) at a graphics processing unit (GPU) or a central processing unit (CPU).

At 1230, GPU 1202 may determine whether each graphics instruction in the set of graphics instructions is associated with a resonance frequency that is above or below a threshold. In some aspects, each graphics instruction of the set of graphics instructions may be further associated with a graphics processing activity that is above or below a power consumption threshold. Also, determining whether each graphics instruction in the set of graphics instructions is associated with the resonance frequency that is above or below the threshold may comprise: determining whether each graphics instruction in the set of graphics instructions is associated with a warp injection mode.

At 1240, GPU 1202 may output, based on the determination, an indication to adjust the activity level of each graphics instruction in the set of graphics instructions based on the resonance frequency being above or below the threshold. For example, GPU 1202 may output indication 1242 to CPU/GPU 1204. In some aspects, outputting the indication to adjust the activity level of each graphics instruction may comprise: transmitting an identifier (ID) for each graphics instruction in the set of graphics instructions based on the resonance frequency being above or below the threshold. Also, outputting the indication to adjust the activity level of each graphics instruction may comprise: transmitting a warp injection flag that indicates to adjust the activity level of each graphics instruction in the set of graphics instructions based on the resonance frequency being above or below the threshold.

At 1250, GPU 1202 may adjust an activity level for each graphics instruction in the set of graphics instructions based on the resonance frequency being above or below the threshold. In some aspects, adjusting the activity level of each graphics instruction in the set of graphics instructions may comprise: adjusting, during a resonance period, the activity level of each graphics instruction in the set of graphics instructions. Also, adjusting the activity level of each graphics instruction in the set of graphics instructions may comprise: adjusting the activity level of each graphics instruction in the set of graphics instructions to be higher or lower than the threshold. Further, adjusting the activity level of each graphics instruction in the set of graphics instructions may comprise: adjusting a number of arithmetic logic units (ALUs) for processing each graphics instruction in the set of graphics instructions. Also, adjusting the activity level of each graphics instruction in the set of graphics instructions may comprise: increasing or decreasing a power level for the set of graphics instructions based on the resonance frequency being above or below the threshold. Moreover, the set of graphics instructions may be at least one of a warp, a set of single-instruction multiple threads (SIMT), or a set of single-instruction multiple data (SIMD).

At 1260, GPU 1202 may output an indication of a set of dummy warps to indicate the adjustment of the activity level of each graphics instruction in the set of graphics instructions. For example, GPU 1202 may output or transmit indication 1262 to CPU/GPU 1204.

At 1270, GPU 1202 may refrain from adjusting the activity level of any graphics instruction in the set of graphics instructions that is outside of a resonance period. In some aspects, the resonance period may be associated with a periodic fluctuation in a power demand at a graphics processing unit (GPU) or a central processing unit (CPU).

At 1280, GPU 1202 may output an indication of the adjustment of the activity level of each graphics instruction in the set of graphics instructions. In some aspects, outputting the indication of the adjustment of the activity level of each graphics instruction in the set of graphics instructions may comprise transmitting the indication of the adjustment of the activity level of each graphics instruction in the set of graphics instructions. For example, GPU 1202 may transmit indication 1282 to CPU/GPU 1204. Also, outputting the indication of the adjustment of the activity level of each graphics instruction in the set of graphics instructions may comprise storing the indication of the adjustment of the activity level of each graphics instruction in the set of graphics instructions. For example, GPU 1202 may store indication 1284 in memory 1206.

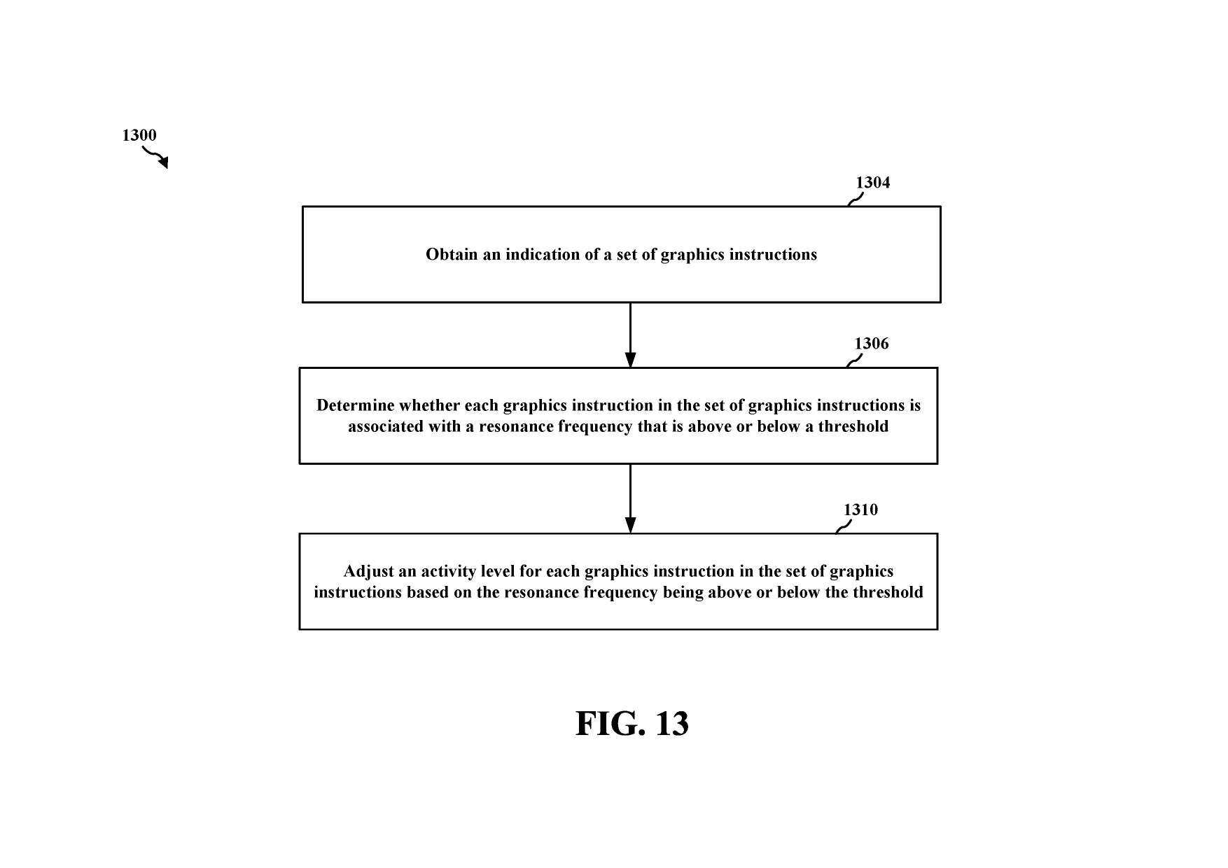

FIG. 13 is a flowchart 1300 of an example method of graphics processing in accordance with one or more techniques of this disclosure. The method may be performed by a GPU (e.g., a GPU, a graphics pipeline at a GPU a shader processor at a GPU, a GPU component, another graphics processor, a CPU, a CPU component, or another central processor), a CPU (e.g., a CPU, a CPU component, another central processor, a GPU, a shader processor at a GPU, a GPU component, or another graphics processor), a display driver integrated circuit (DDIC), an apparatus for graphics processing, a wireless communication device, and/or any apparatus that may perform graphics processing as used in connection with the examples of FIGS. 1-12.

At 1304, the GPU may obtain an indication of a set of graphics instructions, as described in connection with the examples in FIGS. 1-12. For example, as described in 1220 of FIG. 12, GPU 1202 may obtain an indication of a set of graphics instructions. Further, step 1304 may be performed by processing unit 120 in FIG. 1. For example, GPU 1202 may obtain indication 1222 from CPU/GPU 1204. In some aspects, obtaining the indication of the set of graphics instructions may comprise: obtaining the indication of the set of graphics instructions for an arithmetic logic unit (ALU) at a graphics processing unit (GPU) or a central processing unit (CPU).

At 1306, the GPU may determine whether each graphics instruction in the set of graphics instructions is associated with a resonance frequency that is above or below a threshold, as described in connection with the examples in FIGS. 1-12. For example, as described in 1230 of FIG. 12, GPU 1202 may determine whether each graphics instruction in the set of graphics instructions is associated with a resonance frequency that is above or below a threshold. Further, step 1306 may be performed by processing unit 120 in FIG. 1. In some aspects, each graphics instruction of the set of graphics instructions may be further associated with a graphics processing activity that is above or below a power consumption threshold. Also, determining whether each graphics instruction in the set of graphics instructions is associated with the resonance frequency that is above or below the threshold may comprise: determining whether each graphics instruction in the set of graphics instructions is associated with a warp injection mode.

At 1310, the GPU may adjust an activity level for each graphics instruction in the set of graphics instructions based on the resonance frequency being above or below the threshold, as described in connection with the examples in FIGS. 1-12. For example, as described in 1250 of FIG. 12, GPU 1202 may adjust an activity level for each graphics instruction in the set of graphics instructions based on the resonance frequency being above or below the threshold. Further, step 1310 may be performed by processing unit 120 in FIG. 1. In some aspects, adjusting the activity level of each graphics instruction in the set of graphics instructions may comprise: adjusting, during a resonance period, the activity level of each graphics instruction in the set of graphics instructions. Also, adjusting the activity level of each graphics instruction in the set of graphics instructions may comprise: adjusting the activity level of each graphics instruction in the set of graphics instructions to be higher or lower than the threshold. Further, adjusting the activity level of each graphics instruction in the set of graphics instructions may comprise: adjusting a number of arithmetic logic units (ALUs) for processing each graphics instruction in the set of graphics instructions. Also, adjusting the activity level of each graphics instruction in the set of graphics instructions may comprise: increasing or decreasing a power level for the set of graphics instructions based on the resonance frequency being above or below the threshold. Moreover, the set of graphics instructions may be at least one of a warp, a set of single-instruction multiple threads (SIMT), or a set of single-instruction multiple data (SIMD).

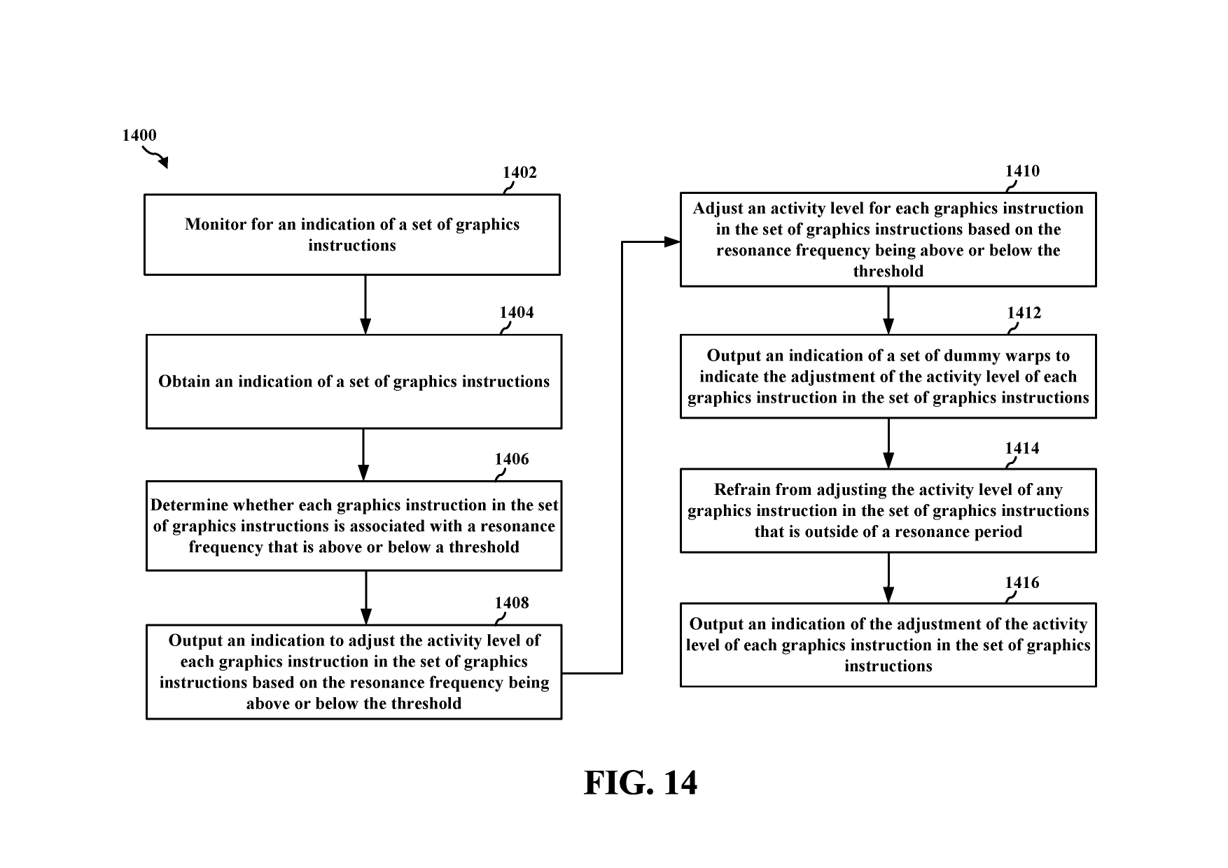

FIG. 14 is a flowchart 1400 of an example method of graphics processing in accordance with one or more techniques of this disclosure. The method may be performed by a GPU (e.g., a GPU, a graphics pipeline at a GPU a shader processor at a GPU, a GPU component, another graphics processor, a CPU, a CPU component, or another central processor), a CPU (e.g., a CPU, a CPU component, another central processor, a GPU, a shader processor at a GPU, a GPU component, or another graphics processor), a display driver integrated circuit (DDIC), an apparatus for graphics processing, a wireless communication device, and/or any apparatus that may perform graphics processing as used in connection with the examples of FIGS. 1-12.

At 1402, the GPU may monitor, during a resonance period, for an indication of a set of graphics instructions prior to obtaining the indication of the set of graphics instructions, as described in connection with the examples in FIGS. 1-12. For example, as described in 1210 of FIG. 12, GPU 1202 may monitor, during a resonance period, for an indication of a set of graphics instructions prior to obtaining the indication of the set of graphics instructions. Further, step 1402 may be performed by processing unit 120 in FIG. 1.

At 1404, the GPU may obtain an indication of a set of graphics instructions, as described in connection with the examples in FIGS. 1-12. For example, as described in 1220 of FIG. 12, GPU 1202 may obtain an indication of a set of graphics instructions. Further, step 1404 may be performed by processing unit 120 in FIG. 1. For example, GPU 1202 may obtain indication 1222 from CPU/GPU 1204. In some aspects, obtaining the indication of the set of graphics instructions may comprise: obtaining the indication of the set of graphics instructions for an arithmetic logic unit (ALU) at a graphics processing unit (GPU) or a central processing unit (CPU).

At 1406, the GPU may determine whether each graphics instruction in the set of graphics instructions is associated with a resonance frequency that is above or below a threshold, as described in connection with the examples in FIGS. 1-12. For example, as described in 1230 of FIG. 12, GPU 1202 may determine whether each graphics instruction in the set of graphics instructions is associated with a resonance frequency that is above or below a threshold. Further, step 1406 may be performed by processing unit 120 in FIG. 1. In some aspects, each graphics instruction of the set of graphics instructions may be further associated with a graphics processing activity that is above or below a power consumption threshold. Also, determining whether each graphics instruction in the set of graphics instructions is associated with the resonance frequency that is above or below the threshold may comprise: determining whether each graphics instruction in the set of graphics instructions is associated with a warp injection mode.

At 1408, the GPU may output, based on the determination, an indication to adjust the activity level of each graphics instruction in the set of graphics instructions based on the resonance frequency being above or below the threshold, as described in connection with the examples in FIGS. 1-12. For example, as described in 1240 of FIG. 12, GPU 1202 may output, based on the determination, an indication to adjust the activity level of each graphics instruction in the set of graphics instructions based on the resonance frequency being above or below the threshold. Further, step 1408 may be performed by processing unit 120 in FIG. 1. In some aspects, outputting the indication to adjust the activity level of each graphics instruction may comprise: transmitting an identifier (ID) for each graphics instruction in the set of graphics instructions based on the resonance frequency being above or below the threshold. Also, outputting the indication to adjust the activity level of each graphics instruction may comprise: transmitting a warp injection flag that indicates to adjust the activity level of each graphics instruction in the set of graphics instructions based on the resonance frequency being above or below the threshold.

At 1410, the GPU may adjust an activity level for each graphics instruction in the set of graphics instructions based on the resonance frequency being above or below the threshold, as described in connection with the examples in FIGS. 1-12. For example, as described in 1250 of FIG. 12, GPU 1202 may adjust an activity level for each graphics instruction in the set of graphics instructions based on the resonance frequency being above or below the threshold. Further, step 1410 may be performed by processing unit 120 in FIG. 1. In some aspects, adjusting the activity level of each graphics instruction in the set of graphics instructions may comprise: adjusting, during a resonance period, the activity level of each graphics instruction in the set of graphics instructions. Also, adjusting the activity level of each graphics instruction in the set of graphics instructions may comprise: adjusting the activity level of each graphics instruction in the set of graphics instructions to be higher or lower than the threshold. Further, adjusting the activity level of each graphics instruction in the set of graphics instructions may comprise: adjusting a number of arithmetic logic units (ALUs) for processing each graphics instruction in the set of graphics instructions. Also, adjusting the activity level of each graphics instruction in the set of graphics instructions may comprise: increasing or decreasing a power level for the set of graphics instructions based on the resonance frequency being above or below the threshold. Moreover, the set of graphics instructions may be at least one of a warp, a set of single-instruction multiple threads (SIMT), or a set of single-instruction multiple data (SIMD).

At 1412, the GPU may output an indication of a set of dummy warps to indicate the adjustment of the activity level of each graphics instruction in the set of graphics instructions, as described in connection with the examples in FIGS. 1-12. For example, as described in 1260 of FIG. 12, GPU 1202 may output an indication of a set of dummy warps to indicate the adjustment of the activity level of each graphics instruction in the set of graphics instructions. Further, step 1412 may be performed by processing unit 120 in FIG. 1.

At 1414, the GPU may refrain from adjusting the activity level of any graphics instruction in the set of graphics instructions that is outside of a resonance period, as described in connection with the examples in FIGS. 1-12. For example, as described in 1270 of FIG. 12, GPU 1202 may refrain from adjusting the activity level of any graphics instruction in the set of graphics instructions that is outside of a resonance period. Further, step 1414 may be performed by processing unit 120 in FIG. 1. In some aspects, the resonance period may be associated with a periodic fluctuation in a power demand at a graphics processing unit (GPU) or a central processing unit (CPU).

At 1416, the GPU may output an indication of the adjustment of the activity level of each graphics instruction in the set of graphics instructions, as described in connection with the examples in FIGS. 1-12. For example, as described in 1280 of FIG. 12, GPU 1202 may output an indication of the adjustment of the activity level of each graphics instruction in the set of graphics instructions. Further, step 1416 may be performed by processing unit 120 in FIG. 1. In some aspects, outputting the indication of the adjustment of the activity level of each graphics instruction in the set of graphics instructions may comprise transmitting the indication of the adjustment of the activity level of each graphics instruction in the set of graphics instructions. For example, GPU 1202 may transmit indication 1282 to CPU/GPU 1204. Also, outputting the indication of the adjustment of the activity level of each graphics instruction in the set of graphics instructions may comprise storing the indication of the adjustment of the activity level of each graphics instruction in the set of graphics instructions. For example, GPU 1202 may store indication 1284 in memory 1206.

In configurations, a method or an apparatus for graphics processing is provided. The apparatus may be a GPU (or other graphics processor), a CPU (or other central processor), a DDIC, an apparatus for graphics processing, and/or some other processor that may perform graphics processing. In aspects, the apparatus may be the processing unit 120 within the device 104, or may be some other hardware within the device 104 or another device. The apparatus, e.g., processing unit 120, may include means for obtaining an indication of a set of graphics instructions. The apparatus, e.g., processing unit 120, may also include means for determining whether each graphics instruction in the set of graphics instructions is associated with a resonance frequency that is above or below a threshold. The apparatus, e.g., processing unit 120, may also include means for adjusting an activity level for each graphics instruction in the set of graphics instructions based on the resonance frequency being above or below the threshold. The apparatus, e.g., processing unit 120, may also include means for outputting, based on the determination, an indication to adjust the activity level of each graphics instruction in the set of graphics instructions based on the resonance frequency being above or below the threshold. The apparatus, e.g., processing unit 120, may also include means for outputting an indication of a set of dummy warps to indicate the adjustment of the activity level of each graphics instruction in the set of graphics instructions. The apparatus, e.g., processing unit 120, may also include means for refraining from adjusting the activity level of any graphics instruction in the set of graphics instructions that is outside of a resonance period. The apparatus, e.g., processing unit 120, may also include means for monitoring, during a resonance period, for the indication of the set of graphics instructions prior to obtaining the indication of the set of graphics instructions. The apparatus, e.g., processing unit 120, may also include means for outputting an indication of the adjustment of the activity level of each graphics instruction in the set of graphics instructions.

The subject matter described herein may be implemented to realize one or more benefits or advantages. For instance, the described graphics processing techniques may be used by a GPU, a shader processor, a CPU, a central processor, or some other processor that may perform graphics processing to implement the resonance mitigation techniques described herein. This may also be accomplished at a low cost compared to other graphics processing techniques. Moreover, the graphics processing techniques herein may improve or speed up data processing or execution. Further, the graphics processing techniques herein may improve resource or data utilization and/or resource efficiency. Additionally, aspects of the present disclosure may utilize resonance mitigation techniques in order to improve memory bandwidth efficiency and/or increase processing speed at a GPU, a shader processor, a CPU, or a display processing unit (DPU).

It is understood that the specific order or hierarchy of blocks in the processes / flowcharts disclosed is an illustration of example approaches. Based upon design preferences, it is understood that the specific order or hierarchy of blocks in the processes / flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

In accordance with this disclosure, the term “or” may be interpreted as “and/or” where context does not dictate otherwise. Additionally, while phrases such as “one or more” or “at least one” or the like may have been used for some features disclosed herein but not others, the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that may be accessed by one or more computers or one or more processors to retrieve instructions, code and/or data structures for implementation of the techniques described in this disclosure. By way of example, and not limitation, such computer-readable media may comprise RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is an apparatus for graphics processing, including at least one memory; and at least one processor coupled to the at least one memory and, based at least in part on information stored in the at least one memory, the at least one processor, individually or in any combination, is configured to: obtain an indication of a set of graphics instructions; determine whether each graphics instruction in the set of graphics instructions is associated with a resonance frequency that is above or below a threshold; and adjust an activity level for each graphics instruction in the set of graphics instructions based on the resonance frequency being above or below the threshold.

Aspect 2 is the apparatus of aspect 1, wherein the at least one processor, individually or in any combination, is further configured to: output, based on the determination, an indication to adjust the activity level of each graphics instruction in the set of graphics instructions based on the resonance frequency being above or below the threshold.

Aspect 3 is the apparatus of aspect 2, wherein to output the indication to adjust the activity level of each graphics instruction, the at least one processor, individually or in any combination, is configured to: transmit an identifier (ID) for each graphics instruction in the set of graphics instructions based on the resonance frequency being above or below the threshold.

Aspect 4 is the apparatus of any of aspects 2 to 3, wherein to output the indication to adjust the activity level of each graphics instruction, the at least one processor, individually or in any combination, is configured to: transmit a warp injection flag that indicates to adjust the activity level of each graphics instruction in the set of graphics instructions based on the resonance frequency being above or below the threshold.

Aspect 5 is the apparatus of any of aspects 1 to 4, wherein the at least one processor, individually or in any combination, is further configured to: output an indication of a set of dummy warps to indicate the adjustment of the activity level of each graphics instruction in the set of graphics instructions.

Aspect 6 is the apparatus of any of aspects 1 to 5, wherein to adjust the activity level of each graphics instruction in the set of graphics instructions, the at least one processor, individually or in any combination, is configured to: adjust, during a resonance period, the activity level of each graphics instruction in the set of graphics instructions.

Aspect 7 is the apparatus of any of aspects 1 to 6, wherein to adjust the activity level of each graphics instruction in the set of graphics instructions, the at least one processor, individually or in any combination, is configured to: adjust the activity level of each graphics instruction in the set of graphics instructions to be higher or lower than the threshold.

Aspect 8 is the apparatus of any of aspects 1 to 7, wherein to adjust the activity level of each graphics instruction in the set of graphics instructions, the at least one processor, individually or in any combination, is configured to: adjust a number of arithmetic logic units (ALUs) for processing each graphics instruction in the set of graphics instructions.

Aspect 9 is the apparatus of any of aspects 1 to 8, wherein the at least one processor, individually or in any combination, is further configured to: refrain from adjusting the activity level of any graphics instruction in the set of graphics instructions that is outside of a resonance period.

Aspect 10 is the apparatus of aspect 9, wherein the resonance period is associated with a periodic fluctuation in a power demand at a graphics processing unit (GPU) or a central processing unit (CPU).

Aspect 11 is the apparatus of any of aspects 1 to 10, wherein to adjust the activity level of each graphics instruction in the set of graphics instructions, the at least one processor, individually or in any combination, is configured to: increase or decrease a power level for the set of graphics instructions based on the resonance frequency being above or below the threshold.

Aspect 12 is the apparatus of aspect 11, wherein the set of graphics instructions is a warp, a set of single-instruction multiple threads (SIMT), or a set of single-instruction multiple data (SIMD).

Aspect 13 is the apparatus of any of aspects 1 to 12, wherein the at least one processor, individually or in any combination, is further configured to: monitor, during a resonance period, for the indication of the set of graphics instructions prior to obtaining the indication of the set of graphics instructions.

Aspect 14 is the apparatus of any of aspects 1 to 13, wherein to obtain the indication of the set of graphics instructions, the at least one processor, individually or in any combination, is configured to: obtain the indication of the set of graphics instructions for an arithmetic logic unit (ALU) at a graphics processing unit (GPU) or a central processing unit (CPU).

Aspect 15 is the apparatus of any of aspects 1 to 14, wherein each graphics instruction of the set of graphics instructions is further associated with a graphics processing activity that is above or below a power consumption threshold.

Aspect 16 is the apparatus of any of aspects 1 to 15, wherein to determine whether each graphics instruction in the set of graphics instructions is associated with the resonance frequency that is above or below the threshold, the at least one processor, individually or in any combination, is configured to: determine whether each graphics instruction in the set of graphics instructions is associated with a warp injection mode.

Aspect 17 is the apparatus of any of aspects 1 to 16, wherein the at least one processor, individually or in any combination, is further configured to: output an indication of the adjustment of the activity level of each graphics instruction in the set of graphics instructions.

Aspect 18 is the apparatus of aspect 17, wherein to output the indication of the adjustment of the activity level of each graphics instruction in the set of graphics instructions, the at least one processor, individually or in any combination, is configured to: transmit the indication of the adjustment of the activity level of each graphics instruction in the set of graphics instructions; or store the indication of the adjustment of the activity level of each graphics instruction in the set of graphics instructions.

Aspect 19 is the apparatus of aspect 18, wherein the apparatus is a wireless communication device, further including (i.e., comprising) at least one of an antenna or a transceiver coupled to the at least one processor, wherein to transmit the indication of the adjustment of the activity level of each graphics instruction, the at least one processor is configured to: transmit, via at least one of the antenna or the transceiver, the indication of the adjustment of the activity level of each graphics instruction.

Aspect 20 is a method of graphics processing for implementing any of aspects 1 to 19.

Aspect 21 is an apparatus for graphics processing including means for implementing any of aspects 1 to 19.

Aspect 22 is a computer-readable medium (e.g., a non-transitory computer-readable medium) storing computer executable code (e.g., code for graphics processing), the code when executed by a processor causes the processor to implement any of aspects 1 to 19.

What is claimed is:

1. An apparatus for graphics processing, comprising:
at least one memory; and
at least one processor coupled to the at least one memory and, based at least in part on information stored in the at least one memory, the at least one processor, individually or in any combination, is configured to:
obtain an indication of a set of graphics instructions;
determine whether each graphics instruction in the set of graphics instructions is associated with a resonance frequency that is above or below a threshold; and
adjust an activity level for each graphics instruction in the set of graphics instructions based on the resonance frequency being above or below the threshold.

2. The apparatus of claim 1, wherein the at least one processor, individually or in any combination, is further configured to:
output, based on the determination, an indication to adjust the activity level of each graphics instruction in the set of graphics instructions based on the resonance frequency being above or below the threshold.

3. The apparatus of claim 2, wherein to output the indication to adjust the activity level of each graphics instruction, the at least one processor, individually or in any combination, is configured to: transmit an identifier (ID) for each graphics instruction in the set of graphics instructions based on the resonance frequency being above or below the threshold.

4. The apparatus of claim 2, wherein to output the indication to adjust the activity level of each graphics instruction, the at least one processor, individually or in any combination, is configured to: transmit a warp injection flag that indicates to adjust the activity level of each graphics instruction in the set of graphics instructions based on the resonance frequency being above or below the threshold.

5. The apparatus of claim 1, wherein the at least one processor, individually or in any combination, is further configured to:
output an indication of a set of dummy warps to indicate the adjustment of the activity level of each graphics instruction in the set of graphics instructions.

6. The apparatus of claim 1, wherein to adjust the activity level of each graphics instruction in the set of graphics instructions, the at least one processor, individually or in any combination, is configured to: adjust, during a resonance period, the activity level of each graphics instruction in the set of graphics instructions.

7. The apparatus of claim 1, wherein to adjust the activity level of each graphics instruction in the set of graphics instructions, the at least one processor, individually or in any combination, is configured to: adjust the activity level of each graphics instruction in the set of graphics instructions to be higher or lower than the threshold.

8. The apparatus of claim 1, wherein to adjust the activity level of each graphics instruction in the set of graphics instructions, the at least one processor, individually or in any combination, is configured to: adjust a number of arithmetic logic units (ALUs) for processing each graphics instruction in the set of graphics instructions.

9. The apparatus of claim 1, wherein the at least one processor, individually or in any combination, is further configured to:
refrain from adjusting the activity level of any graphics instruction in the set of graphics instructions that is outside of a resonance period.

10. The apparatus of claim 9, wherein the resonance period is associated with a periodic fluctuation in a power demand at a graphics processing unit (GPU) or a central processing unit (CPU).

11. The apparatus of claim 1, wherein to adjust the activity level of each graphics instruction in the set of graphics instructions, the at least one processor, individually or in any combination, is configured to: increase or decrease a power level for the set of graphics instructions based on the resonance frequency being above or below the threshold.

12. The apparatus of claim 11, wherein the set of graphics instructions is a warp, a set of single-instruction multiple threads (SIMT), or a set of single-instruction multiple data (SIMD).

13. The apparatus of claim 1, wherein the at least one processor, individually or in any combination, is further configured to:
monitor, during a resonance period, for the indication of the set of graphics instructions prior to obtaining the indication of the set of graphics instructions.

14. The apparatus of claim 1, wherein to obtain the indication of the set of graphics instructions, the at least one processor, individually or in any combination, is configured to: obtain the indication of the set of graphics instructions for an arithmetic logic unit (ALU) at a graphics processing unit (GPU) or a central processing unit (CPU).

15. The apparatus of claim 1, wherein each graphics instruction of the set of graphics instructions is further associated with a graphics processing activity that is above or below a power consumption threshold.

16. The apparatus of claim 1, wherein to determine whether each graphics instruction in the set of graphics instructions is associated with the resonance frequency that is above or below the threshold, the at least one processor, individually or in any combination, is configured to: determine whether each graphics instruction in the set of graphics instructions is associated with a warp injection mode.

17. The apparatus of claim 1, wherein the at least one processor, individually or in any combination, is further configured to:
output an indication of the adjustment of the activity level of each graphics instruction in the set of graphics instructions.

18. The apparatus of claim 17, wherein to output the indication of the adjustment of the activity level of each graphics instruction in the set of graphics instructions, the at least one processor, individually or in any combination, is configured to:
transmit the indication of the adjustment of the activity level of each graphics instruction in the set of graphics instructions; or
store the indication of the adjustment of the activity level of each graphics instruction in the set of graphics instructions.

19. A method of graphics processing, comprising:
obtaining an indication of a set of graphics instructions;
determining whether each graphics instruction in the set of graphics instructions is associated with a resonance frequency that is above or below a threshold; and
adjusting an activity level for each graphics instruction in the set of graphics instructions based on the resonance frequency being above or below the threshold.

20. A computer-readable medium storing computer executable code for graphics processing, the code when executed by a processor causes the processor to:
obtain an indication of a set of graphics instructions;
determine whether each graphics instruction in the set of graphics instructions is associated with a resonance frequency that is above or below a threshold; and
adjust an activity level for each graphics instruction in the set of graphics instructions based on the resonance frequency being above or below the threshold.
